(19) United States
(12) Patent Application Publication
(10) Pub. No.: US 2026/0268170 A1
(43) Pub. Date: Sep. 10, 2026

(54) INFORMATION PROCESSING DEVICE, INFORMATION PROCESSING METHOD, AND COMPUTER PROGRAM

(71) Applicant: Sony Group Corporation, Tokyo (JP)

(72) Inventors: Atsushi NODA, Tokyo (JP); Takashi ISOZAKI, Tokyo (JP)

(73) Assignee: Sony Group Corporation, Tokyo (JP)

(21) Appl. No.: 18/869,300

(22) PCT Filed: Apr. 13, 2023
(86) PCT No.: PCT/JP2023/015083

§ 371 Date: Oct. 22, 2025

(30) Foreign Application Priority Data
Jun. 7, 2022 (JP) 2022-092438

(51) Int. Cl. G06N 5/02

(52) U.S. Cl. CPC G06N 5/02

(57) ABSTRACT

Provided is an information processing device that performs processing related to multivariable data analysis.

An information processing device includes a graph inspection unit that performs an inspection of edge direction in a causal graph when performing an intervention effect calculation from an intervention variable to a reaction variable in the causal graph, and a presentation unit that presents information regarding necessity of directing of a part of edges, specifically, edges adjacent to the intervention variable and the reaction variable on the basis of a result of the inspection of edge direction by the graph inspection unit. The graph inspection unit inspects a direction of an edge adjacent to the intervention variable and the reaction variable, and the presentation unit presents an edge that needs to be directed adjacent to the intervention variable and the reaction variable.

### TECHNICAL FIELD

The technology disclosed in the present specification (hereinafter, “the present disclosure”) relates to an information processing device, an information processing method, and a computer program that perform a process related to multivariable data analysis.

### BACKGROUND ART

In the analysis of multivariable data, there are various techniques such as deep learning and gradient boosting for predicting a value of an objective variable from other variables. However, since these prediction techniques use a correlation instead of a causal relationship between variables, it is not possible to calculate a causal influence exerted on an objective variable or another variable in a case where a value of a variable is changed. However, a correlation means a relationship between two or more things, and a causal relationship means a relationship between a cause and a result between two or more things (for example, it can be said that there is a causal relationship between x₁ and x₂ in a case where x₂ changes with a change in the variable x₁, whereas it can be said that there is a correlation between x₂ and x₃ in a case where x₂ and x₃ change with a change in the variable x₁).

On the other hand, it is possible to estimate a causal relationship between variables by an intervention operation of assigning a specific value to any variable. For example, there has been proposed a causal relationship estimation device including a query identification unit that identifies a query that is a combination of a variable with which an intervention operation is performed for a causal relationship and a value of the variable, an intervention data generation unit that generates intervention data including a value of a target variable acquired by an intervention operation based on a query and the query, and a causal relationship update unit that updates a causal relationship using the generated intervention data, in which the query identification unit identifies a query that minimizes an expected loss by update among queries identified on the basis of an expected loss representing an estimation error of the target variable by the query (see Patent Document 1).

Calculating a causal influence that a certain variable receives in a case where a value of another variable is changed is called intervention effect calculation. Although research on intervention effect calculation is advancing academic, there are few examples in which intervention effect calculation is used in business in the real world.

Note that, in the present specification, a variable that virtually changes a value is referred to as an “intervention variable”, and a variable with which intervention effect calculation is performed to examine a causal influence thereof is referred to as a “reaction variable”. However, the name of the reaction variable is only one of the names of the variables for examining the influence of the causal intervention, and any name may be used as long as it is a variable having this meaning. Depending on the field to be used, it is also referred to as a response variable, a reaction variable, an outcome variable, a reference variable, a dependent variable, an explained variable, or the like.

Although a plurality of variables can be intervened simultaneously, they are collectively referred to as intervention variables below. Although a plurality of reaction variables may be calculated, they are collectively referred to as reaction variables below. Furthermore, in the present specification, a variable that affects both the intervention variable and the reaction variable is referred to as a “confounding variable”. The confounding variable should not be a variable that is affected by the intervention variable.

### CITATION LIST

### Patent Document

Patent Document 1: WO2019/220653
Patent Document 2: Japanese Patent Application Laid-Open No. 2008-299524

### SUMMARY OF THE INVENTION

### Problems to be Solved by the Invention

Whether a causal relationship is identified by knowledge or a causal relationship is estimated from data, it is difficult to identify all causal directions, even more particularly in a case of considering a causal relationship in which many variables are involved. In a path diagram and a causal graph that graphically express a causal relationship, an edge represents a causal relationship between nodes to which the edge is connected as a variable, but an edge for which a direction of cause and effect is not determined is referred to as an undirected edge. In the case of performing the intervention effect calculation, there is a case where the calculation cannot be performed with the undirected edge as it is. Therefore, there is a case where it is necessary to give directions to the undirected edges, but there is a first problem that it is difficult for the user to determine whether it is necessary to give directions of all the undirected edges. Furthermore, even if an edge is determined, this calculation may not be performed due to lack of data, and there is also a second problem that practicality is low.

Therefore, an object of the present disclosure is to provide an information processing device, an information processing method, and a computer program that simultaneously solve the first and second problems described above and perform processing for performing practical intervention effect calculation in analysis of multivariable data.

### Solutions to Problems

The present disclosure has been made in view of the above problems, and a first aspect of the present disclosure is an information processing device including
a graph inspection unit that performs an inspection of edge direction in a causal graph when performing an intervention effect calculation from an intervention variable to a reaction variable in the causal graph, and
a presentation unit that presents information regarding necessity of directing of a part of edges on the basis of a result of the inspection of edge direction by the graph inspection unit. Specifically, the presentation unit presents information regarding necessity of directing of an edge adjacent to the intervention variable and the reaction variable.

The graph inspection unit inspects a direction of an edge adjacent to the intervention variable and the reaction variable, and the presentation unit presents an edge that needs to be directed or an edge that does not need to be directed adjacent to the intervention variable and the reaction variable.

Furthermore, the graph inspection unit inspects errors such as presence or absence of a directed path from the intervention variable to the reaction variable and the presence or absence of circulation, and the presentation unit presents information regarding an error that has occurred and information on a coping method.

Furthermore, the information processing device according to the first aspect further includes a user input unit that receives correction of information presented by the presentation unit from the user, and an intervention effect calculation unit that calculates an intervention effect from the intervention variable to the reaction variable on the basis of the causal graph corrected via the input unit. The intervention effect calculation unit calculates an intervention effect from the intervention variable to the reaction variable on the basis of a causal graph corrected in such a manner that only an undirected edge adjacent to the intervention variable is directed via the input unit.

Furthermore, the information processing device according to the first aspect further includes a variable extraction unit that extracts a set of confounding variables that satisfy a backdoor criterion regardless of a direction of an undirected edge in the causal graph, and an intervention effect calculation unit that calculates an intervention effect from an intervention variable to a reaction variable by averaging, with a distribution of each of the confounding variables, results of evaluating a causal effect from the intervention variable to the reaction variable as a conditional distribution when stratified by the confounding variables that satisfy the backdoor criterion.

Furthermore, the information processing device according to the first aspect further includes a confounding variable search unit that searches for a confounding variable to be used for intervention effect calculation on the basis of a result of aggregation of a combination of a value of the intervention variable and a value of the confounding variable, and a second presentation unit that presents information based on a result of the inspection by the confounding variable inspection unit.

The second presentation unit presents whether or not a combined data amount is sufficient. Moreover, the second presentation unit performs at least one of presentation of information regarding selection of a confounding variable to be used for intervention effect calculation, provision of a function of performing highly reliable selection with a largest amount of data among a plurality of the confounding variables to perform intervention effect calculation and presentation of an index value regarding reliability of the selection, or presentation of information regarding a variable that needs input for an individual intervention effect, in a case where there is a plurality of confounding variables with a sufficiently sufficient amount of data in combination.

Furthermore, a second aspect of the present disclosure is an information processing method including:
a graph inspection step of performing an inspection of edge direction in a causal graph when performing an intervention effect calculation from an intervention variable to a reaction variable in the causal graph; and
a presentation step of presenting information regarding necessity of directing of a part of edges on the basis of a result of the inspection of edge direction by the graph inspection step.

Furthermore, a third aspect of the present disclosure is a computer program described in a computer readable format to cause a computer to function as:
a graph inspection unit that performs an inspection of edge direction in a causal graph when performing an intervention effect calculation from an intervention variable to a reaction variable in the causal graph; and
a presentation unit that presents information regarding necessity of directing of a part of edges on the basis of a result of the inspection of edge direction by the graph inspection unit.

The computer program according to the third aspect of the present disclosure defines a computer program described in a computer-readable format so as to implement predetermined processing on a computer. In other words, by installing the computer program according to the third aspect of the present disclosure in the computer, the computer can perform a cooperative operation and produce effects similar to those produced by the information processing device according to the first aspect of the present disclosure.

### Effects of the Invention

According to the present disclosure, it is possible to provide an information processing device, an information processing method, and a computer program that perform processing for performing practical intervention effect calculation in analysis of multivariable data.

Note that the effects described in the present specification are merely examples, and the effects to be brought by the present disclosure are not limited thereto. Furthermore, there are cases where the present disclosure further provides some other effects, in addition to the effects described above.

Still other objects, features, and advantages of the present disclosure will become apparent from a more detailed description based on embodiments as described later and the accompanying drawings.

### BRIEF DESCRIPTION OF DRAWINGS

FIG. 1 is a flowchart illustrating a processing procedure performed when an information processing device to which the present disclosure is applied performs processing related to multivariable data analysis.

FIG. 2 is a diagram illustrating a configuration example of a UI screen that presents candidates of an intervention variable.

FIG. 3 is a diagram illustrating an example of a causal graph in which an undirected edge is adjacent to the intervention variable and the reaction variable.

FIG. 4 is a diagram illustrating a configuration example of a UI screen that displays information of an edge that needs to be directed.

FIG. 5 is a diagram illustrating another configuration example of a UI screen that displays information of an edge that does not need to be directed.

FIG. 6 is a diagram illustrating an example of the causal graph without a directed path from the intervention variable to the reaction variable.

FIG. 7 is a diagram illustrating a configuration example of a UI screen that requests the user to direct an edge again and causes a directed path to be present.

FIG. 8 is a diagram illustrating a configuration example of a UI screen for prompting a user to select an intervention variable having a directed path.

FIG. 9 is a diagram illustrating an example of the causal graph in which circulation occurs.

FIG. 10 is a diagram illustrating a configuration example of a UI screen that requests directing of an edge so as to resolve a circulation error.

FIG. 11 is a diagram illustrating an example of the causal graph used in description of a phase of intervention effect calculation.

FIG. 12 is a diagram illustrating a configuration example of a UI screen for notifying that the amount of data sufficient to calculate the intervention effect with high accuracy is sufficient.

FIG. 13 is a diagram illustrating a configuration example (step S114) of a UI screen for allowing a user to select a variable used for intervention effect calculation.

FIG. 14 is a diagram illustrating a configuration example (step S115) of a UI screen that presents variables that need to be input for performing an individual intervention effect to a user.

FIG. 15 is a diagram illustrating a configuration example (step S116) of a UI screen that automatically presents a result of performing intervention effect calculation on all values of confounding variables to a user.

FIG. 16 is a diagram illustrating a configuration example (step S111) of a UI screen for notifying of a portion where a combination of data is insufficient as an error.

FIG. 17 is a diagram illustrating another configuration example (step S111) of the UI screen notifying of a portion where the combination of data is insufficient as an error.

FIG. 18 is a diagram illustrating a configuration example (step S112) of a UI screen for notifying of a portion where a combination of data is insufficient as a warning.

FIG. 19 is a diagram for describing an effect obtained through the UI screen illustrated in FIG. 14.

FIG. 20 is a diagram illustrating a configuration example of an information processing device 2000.

FIG. 21 is a diagram (causal graph) for describing Example (1).

FIG. 22 is a diagram (UI screen that displays information on an edge that needs to be directed) for describing Example (1).

FIG. 23 is a diagram (UI screen that displays information on edges that do not need to be directed) for describing Example (1).

FIG. 24 is a diagram (causal graph) for describing Example (2).

FIG. 25 is a diagram (table illustrating the data amount of each combination of variable values) for describing Example (2).

FIG. 26 is a diagram (table illustrating the data amount of each combination of variable values) for describing Example (2).

FIG. 27 is a diagram (table illustrating the data amount of each combination of variable values) for describing Example (2).

FIG. 28 is a diagram (configuration example of UI screen) for describing Example (2).

FIG. 29 is a diagram (configuration example of UI screen) for describing Example (2).

FIG. 30 is a diagram for describing an algorithm for identifying a variable satisfying the backdoor criterion from the causal graph.

FIG. 31 is a diagram for describing an algorithm for identifying a variable satisfying the backdoor criterion from the causal graph.

FIG. 32 is a diagram for describing an algorithm for identifying a variable satisfying the backdoor criterion from the causal graph.

FIG. 33 is a diagram for describing an algorithm for identifying a variable satisfying the backdoor criterion from the causal graph.

FIG. 34 is a diagram for describing an algorithm for identifying a variable satisfying the backdoor criterion from the causal graph.

FIG. 35 is a diagram for describing an algorithm for identifying a variable satisfying the backdoor criterion from the causal graph.

FIG. 36 is a diagram for describing an algorithm for identifying a variable satisfying the backdoor criterion from the causal graph.

FIG. 37 is a diagram for describing an algorithm for identifying a variable satisfying the backdoor criterion from the causal graph.

FIG. 38 is a diagram for describing an algorithm for identifying a variable satisfying the backdoor criterion from the causal graph.

FIG. 39 is a diagram for describing an algorithm for identifying a variable satisfying the backdoor criterion from the causal graph.

### MODE FOR CARRYING OUT THE INVENTION

Hereinafter, the present disclosure will be described in the following order with reference to the drawings.
A. Outline
B. Regarding intervention effect calculation
C. Extraction of variable candidates
D. Individual intervention effects
E. Operation procedure and UI
F. Device configuration
G. Example (1)
H. Example (2)
I. Summary

### A. Outline

In the analysis of multivariable data, there are few examples of calculating an effect (intervention effect) on another variable by externally changing a value of a certain variable, that is, intervention effect calculation is industrially utilized in the real world although research is advanced academically. At the present time (alternatively, at the time of filing of the present application), most studies assume that a causal relationship is completely known, and it is utilized in an ideal situation where there are infinite (or sufficient) data, or the like. That is, there are a first problem that it is rare that the causal relationship between variables is completely known and the causal relationship in a certain region cannot be known (or cannot be determined) in practical application of the intervention effect calculation, and a second problem that it is often assumed in research that there is infinite data for calculating the intervention effect, and in practice, calculation accuracy deteriorates due to lack of data.

With respect to the first problem that “the causal relationship is not necessarily completely known”, this causes an operation of the user to determine the direction with respect to an edge (undirected edge) whose causal direction is not known. In a case where the number of variables is large and the causal relationship is complicated, it is necessary to determine several tens or several hundreds of directions of edges and the burden on the user becomes excessive, and it becomes difficult to perform analysis. Furthermore, even if the graph is small, the user may not be able to determine the direction because there is no information for determining the direction of cause and effect between variables. Therefore, it is desirable that the number of edges that the user needs to determine the direction is as small as possible.

Regarding the second “finite data in the real world”, even if a variable necessary for intervention calculation is theoretically selected from causal graph information, the combination of data necessary for calculation may be partially insufficient due to the finite data. That is, variable selection for intervention effect calculations needs to be refined to address real-world problems where data is not sufficient.

Accordingly, in relation to the first problem, the present disclosure proposes a method of “causal direction determination” that uses an algorithm to reduce the number of edges that the user needs to determine the direction for calculating the intervention effect, reduces the time and effort of analysis for the user to determine the direction of the edge, and achieves efficient multivariable data analysis. In the present disclosure, by presenting a user interface for a user to determine an edge direction, it is possible to reduce time and effort for analysis and to efficiently perform intervention effect calculation.

Furthermore, in relation to the second problem, the present disclosure proposes a method of “searching for a combination of variables having sufficient data” in order to prevent deterioration of calculation accuracy due to data shortage when performing intervention effect calculation. In the present disclosure, by presenting a user interface for searching for a combination of variables having sufficient data, time and effort for analysis are reduced, and intervention effect calculation can be efficiently performed. Alternatively, in the present disclosure, a combination of variables having sufficient data is searched for, and the calculation is performed using a combination of variables that can calculate the intervention effect with the highest accuracy from the viewpoint of the number of data. In addition, an index value regarding the accuracy is presented to the user, and the user is notified of the reliability of calculation in advance.

### B. Regarding Intervention Effect Calculation

In a case where all variables including an intervention variable and a reaction variable are connected by an independent directed acyclic graph (DAG), and causal semantics are possible for all edges thereof, a causal effect on another variable Y when intervening in a variable X is called an intervention effect. In this case, the variable X is an intervention variable, and the variable Y is a reaction variable. The intervention effect from the variable X to the variable Y in a causal graph with the vertex set as V={X, Y, Z₁, Z₂, . . . , Zₚ} is mathematically defined as in the following Expression (1).

$$\begin{matrix}[ Math . 1 ] & \\ f ( y \vert set ( X = x ) ) = \int … \int \frac{{f}_{V} ( x , y , {z}_{1} , {z}_{2} , … , {z}_{p} )}{{f}_{X \cdot pa} ( x \vert pa ( x ) )} {dz}_{1} … {dz}_{p} & ( 1 )\end{matrix}$$

Here, a correct intervention effect from the variable X to the variable Y does not need to use all the variables on the causal graph for calculation like Z₁ to Zₚ. That is, in a case where {Z₁, Z₂, . . . , Zᵣ} satisfies the backdoor criterion in (X, Y) (where r is smaller than p), the causal effect from the intervention variable X to the reaction variable Y when stratified by them is evaluated as a conditional distribution, and averaged with the distribution of {Z₁, Z₂, . . . , Zᵣ}, the intervention effect can be calculated as illustrated in the following Expression (2).

$$\begin{matrix}[ Math . 2 ] & \\ f ( y \vert set ( X = x ) ) = \int … \int {f}_{Z} ( {z}_{1} , … , {z}_{r} ) {f}_{Y \cdot X Z} ( y \vert x , {z}_{1} , … , {z}_{r} ) {dz}_{1} … {dz}_{r} & ( 2 )\end{matrix}$$

The above Expression (2) means that if the directions of all the edges adjacent to the intervention variable X and the reaction variable Y are determined, the intervention effect from the intervention variable X to the reaction variable Y can be calculated using only the variable {Z₁, Z₂, . . . , Zᵣ} satisfying the backdoor criterion in the causal graph. Here, the variables satisfying the backdoor criterion in (X, Y) means that the pseudo correlation between X and Y can be removed by stratification with those variables.

Accordingly, in the present disclosure, the intervention effect calculation from the intervention variable X to the reaction variable Y is implemented on the basis of the above Expression (2) only by determining the directions of all the edges adjacent to the intervention variable X and the reaction variable Y by applying an algorithm for specifying a variable {Z₁, Z₂, . . . , Zᵣ} satisfying the backdoor criterion from the causal graph.

Then, in the present disclosure, a user interface (UI) that prompts a user operation for determining the directions of all the edges adjacent to the intervention variable X and the reaction variable Y is presented as described later in Section D. Therefore, according to the present disclosure, it is not necessary to know the directions of all the edges on the causal graph at the time of calculating the intervention effect, and thus it is possible to reduce the work load for the user to determine the direction of the edge.

Furthermore, in the present disclosure, in a case where a plurality of (sets of) confounding variables satisfying the backdoor criterion are found through the above algorithm, data is aggregated for each combination of the value of the intervention variable and the value of each confounding variable, and which variable is used for the intervention effect calculation is evaluated. Then, in the present disclosure, as will be described later in Section D, by presenting information regarding variable candidates based on evaluation results to the user, it is possible to reduce the time and effort of analysis by the user and to efficiently perform the intervention effect calculation. Specifically, in the present disclosure, the intervention effect calculation with high accuracy is efficiently implemented by presenting a UI that excludes variables that cause data shortage among a plurality of confounding variables (or prompts the user to exclude them) and selects a confounding variable with high calculation accuracy (or prompts the user to select it). Alternatively, in the present disclosure, the intervention effect calculation is implemented by selecting the confounding variable with the highest calculation accuracy. Then, before the calculation, the index value regarding the highest accuracy is presented to the user so that the user can determine whether analysis can be performed with a sufficient number of data or whether the analysis is executed or withdrawn. Alternatively, it is possible to notify the user of reliability of an analysis result by presenting an index value regarding the highest accuracy to the user after the intervention effect calculation.

### C. Extraction of Variable Candidates

In the above Section B, it has been described that if the directions of all the edges adjacent to the intervention variable and the reaction variable are determined, the intervention effect can be calculated using only a variable satisfying the backdoor criterion in the causal graph, and it is not necessary to calculate using all the variables on the causal graph. In this Section C, an algorithm for identifying a variable satisfying the backdoor criterion from the causal graph will be described.

FIG. 30 schematically illustrates an example of the causal graph. The causal graph includes a plurality of variables including the intervention variable X and the reaction variable Y, and an edge connecting the variables, but in order to simplify the drawing, FIG. 30 illustrates an abstracted path (causal path) including variables (confounding variables) other than the intervention variable X and the reaction variable Y. As a premise, it is assumed that the directions of all the edges adjacent to the intervention variable X and the reaction variable Y have already been determined. Furthermore, in the path, a plurality of variables (confounding variables) and edges connecting the variables are configured, and a directed edge and an undirected edge are included (not illustrated). Here, since there is a directed edge from the path to each of the intervention variable X and the reaction variable Y, the path is a “causal path” that affects both the intervention variable X and the reaction variable Y. The influence of the causal path becomes a bias from the intervention variable X to the reaction variable Y. For this reason, it is necessary to remove the influence of the causal path by including the variable for removing the bias among the variables in the causal path in the intervention effect calculation.

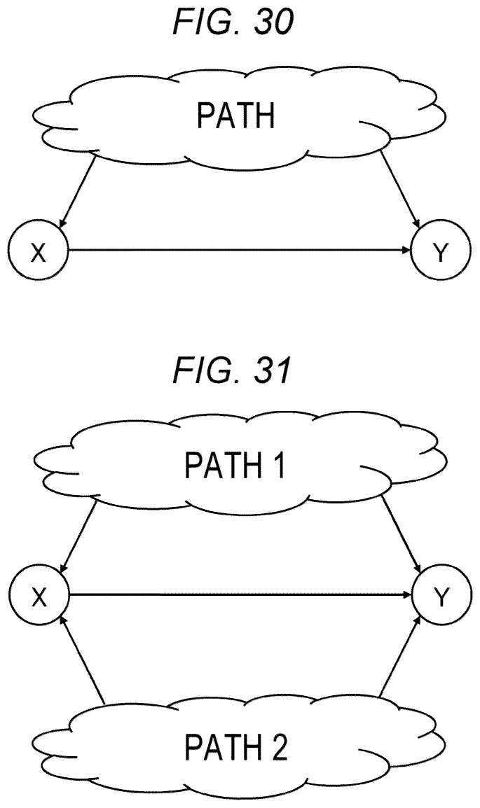

FIG. 30 illustrates a case where there is one causal path as the simplest configuration example of the causal graph, but the causal graph may include a plurality of causal paths. FIG. 31 illustrates a causal graph including two causal paths (“path 1” and “path 2”) for simplification of the drawing. In such a case, a variable for removing the bias to be included in the intervention effect calculation is only required to be selected for each causal path.

Furthermore, FIG. 32 illustrates a configuration example of another causal graph including an intervention variable X, a reaction variable Y, and two paths. In the example illustrated in FIG. 32, unlike the causal graph illustrated in FIG. 31, there are directed ways from the intervention variable X to both of the two paths (“path 1” and “path 2”). That is, any edge connecting the intervention variable X and each path is directed from the intervention variable X to the path, and any path is on the progeny side of the intervention variable X, so that no bias is generated. Therefore, it is not necessary to use variables in any path for the intervention effect calculation. Similarly, regarding the reaction variable Y, a variable on the progeny side of the reaction variable Y does not generate a bias, and hence does not need to be used for the intervention effect calculation. Therefore, it is sufficient to determine the direction of the edge adjacent to the intervention variable X and the reaction variable Y.

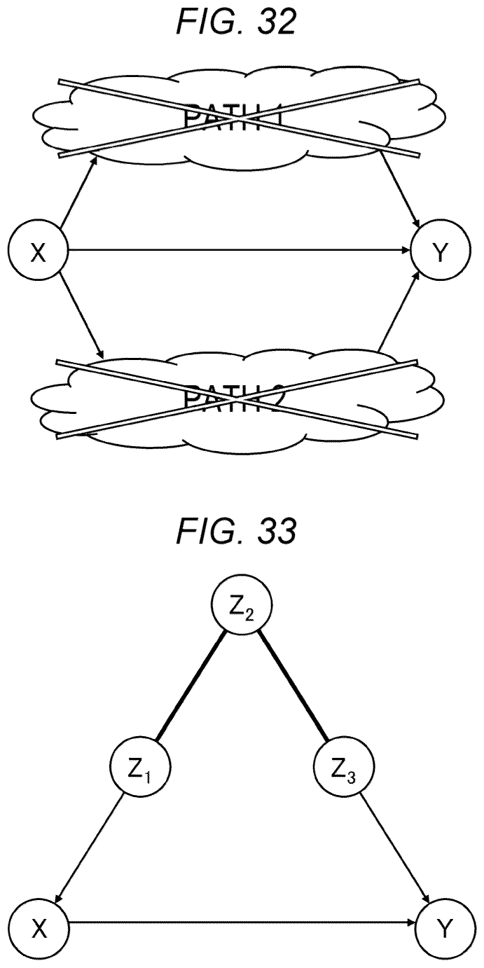

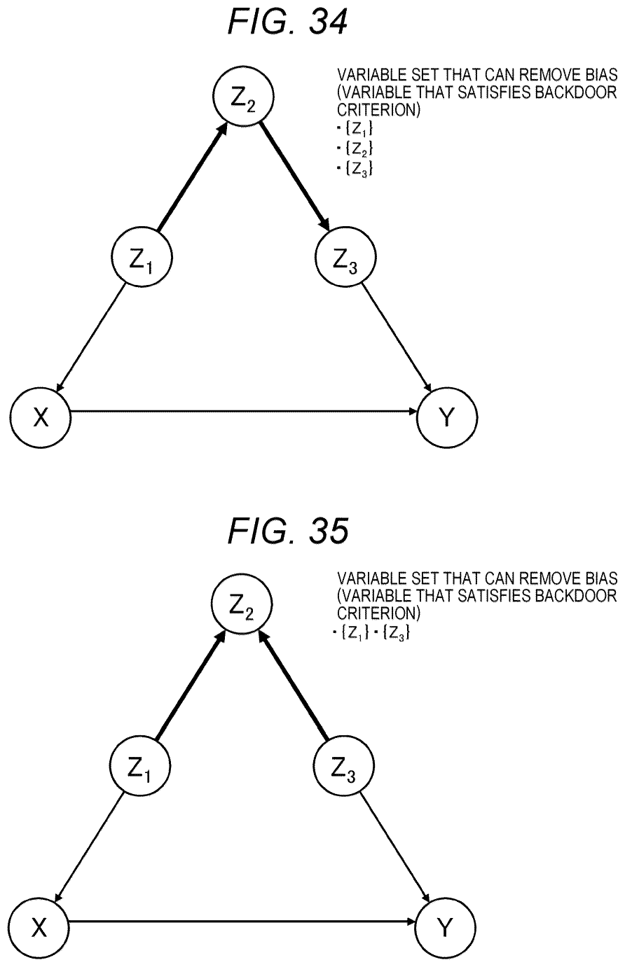

FIG. 33 illustrates a simple configuration example of the causal graph in which a causal path includes three variables Z₁, Z₂, and Z₃. Also in FIG. 33, as a premise, it is assumed that the directions of all the edges adjacent to the intervention variable X and the reaction variable Y have already been determined. However, in the causal path, it is assumed that both the edge connecting the variable Z₁ and the variable Z₂ and the edge connecting the variable Z₂ and the variable Z₃ are undirected. By directing the two undirected edges in FIG. 33, four causal graphs in FIGS. 34 to 37 are conceivable.

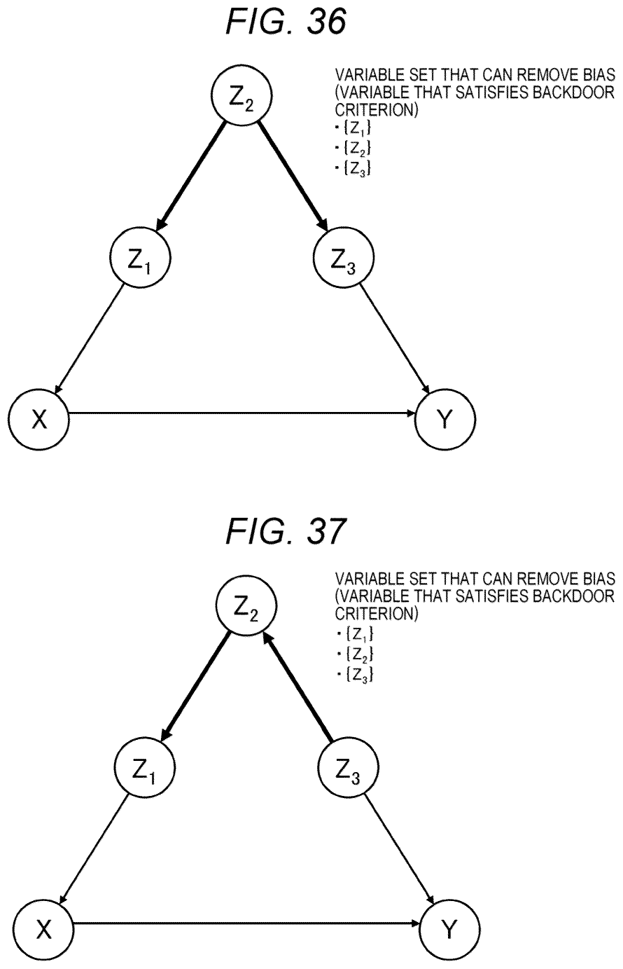

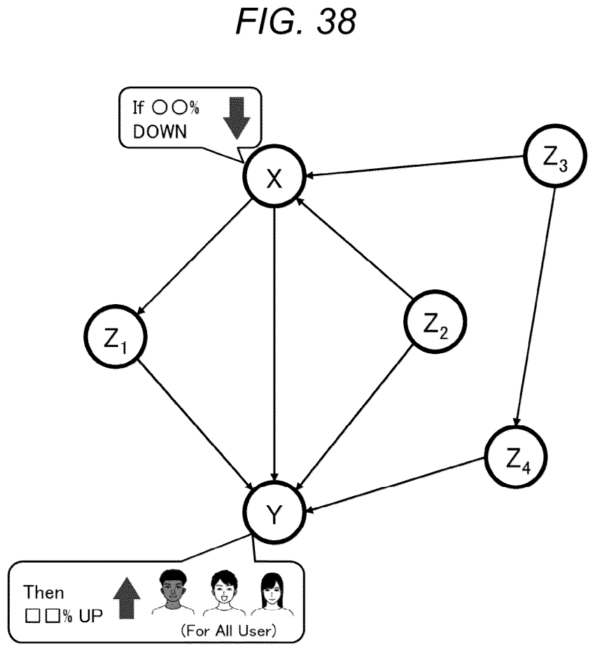

Here, in each of the patterns in FIGS. 34 to 37, a variable from which a bias for the causal effect from the intervention variable X to the reaction variable Y can be removed is searched for. In the pattern illustrated in FIG. 34, the bias can be removed using any one of {Z₁}, {Z₂}, and {Z₃} in the intervention effect calculation. Furthermore, in the pattern illustrated in FIG. 35, the bias can be removed using any one of {Z₁} and {Z₃} in the intervention effect calculation. Furthermore, in the pattern illustrated in FIG. 36, the bias can be removed using any one of {Z₁}, {Z₂}, and {Z₃} in the intervention effect calculation. Furthermore, in the pattern illustrated in FIG. 37, the bias can be removed using any one of {Z₁}, {Z₂}, and {Z₃} in the intervention effect calculation.

When a logical product of directing patterns of four types of undirected edges illustrated in FIGS. 34 to 37 is obtained, the bias can be removed using any one of {Z₁} and {Z₃} in the intervention effect calculation. From the above, it can be seen that when stratification is performed with any one of {Z₁} and {Z₃}, the intervention effect can be calculated by removing the bias. Therefore, since the intervention effect can be calculated without determining the edge direction between the variable Z₁ and the variable Z₂ and the edge direction between the variable Z₂ and the variable Z₃, it is possible for the user to save the labor of determine the direction of the undirected edge in the causal path.

The variables {Z₁} and {Z₃} from which the bias can be removed in the intervention effect calculation are variables that satisfy the backdoor criterion. The “backdoor criterion” in causal inference is well known. Assuming that there is a directed way from X to Y in a causal graph G, it can be said that a vertex set S satisfying the following conditions (a1) and (a2) satisfies the backdoor criterion for (X, Y).

(a1) There is no directed way to any element from X to S (S is not on the progeny side of X).

(a2) In the graph obtained by removing the directed edge from X from the causal graph G, S d-separates X and Y.

The “d-separation” in the above condition (a2) will be further described. For each of all directions connecting two vertexes α and β, when the vertex set S that is exclusive of {α, β} satisfies any one of the following conditions (b1) and (b2), it is said that S d-separates α and β.

(b1) Some junction points on the way connecting α and β and the progeny thereof are not included in S.

(b2) Some non-junction points on the way connecting α and β are included in S.

Note that there is always a set of variables on the causal graph that satisfy the backdoor criterion (in the graph in which the directed edge from X from the causal graph G is removed, when there is no way including only the non-junction points connecting X and Y, the empty set satisfies the backdoor criterion). Furthermore, there is generally a plurality of vertex sets satisfying the backdoor criterion.

In the case of the causal graph in which the number of variables is small as illustrated in FIG. 33, the variable satisfying the backdoor criterion can be easily found, but when the number of variables is large and the causal relationship is complicated, it is difficult for the user to visually find the variable satisfying the backdoor criterion. In such a case, using the graph search technique, it is possible to search for variables satisfying the conditions (a1) and (a2) even from a causal graph with many variables and complicated. However, in order to reduce the calculation amount of the graph search, the search range may be limited to the vicinity of the intervention variable and the reaction variable.

The procedure for calculating the intervention effect using only the variable satisfying the backdoor criterion in the causal graph is organized.

Procedure 1) Confirm that the edges adjacent to the intervention variable X and the reaction variable Y are all directed edges. In a case where there is an undirected edge adjacent to the intervention variable X and the reaction variable Y, it is presented to the user and directing of the edge is requested.

Procedure 2) Search for a variable that can remove a bias to the causal effect from the intervention variable X to the reaction variable Y, that is, a variable that satisfies the backdoor criterion, regardless of the pattern of any combination of the direction of each undirected edge that is not adjacent to the intervention variable X and the reaction variable Y.

The variable satisfying the backdoor criterion can be automatically searched using a graph search technique. The user does not need to do any directing for an undirected edge that is not adjacent to the intervention variable X and the reaction variable Y, so that it is possible to save time and effort.

Procedure 3) Perform intervention effect calculation by guiding to use variables that can be calculated with high accuracy.

In the present disclosure, a result of evaluating the causal effect from the intervention variable to the reaction variable when stratified by the confounding variable satisfying the backdoor criterion as a conditional distribution is averaged with a distribution of each confounding variable, and the intervention effect from the intervention variable to the reaction variable is calculated. At that time, a combination of the value of the intervention variable and the value of the confounding variable is aggregated, and a variable in which data is not insufficient is presented to the user to request selection, or a variable in which data is not insufficient is automatically selected to execute calculation.

### D. Individual Intervention Effects

The individual intervention effect is an intervention effect calculation for individual data or a group. The difference between the overall intervention and the individual intervention effect will be described using a causal graph in which the variable X is an intervention variable, the variable Y is a reaction variable, and four variables Z₁ to Z₄ are confounding variables as illustrated in FIG. 38 as an example. For example, analysis of questionnaire data performed on each customer in a company engaged in the service industry is taken as an example, and the intervention variable X is the satisfaction level with a service A, the reaction variable is the presence or absence of withdrawal, and each of the confounding variables Z₁ to Z₄ is attribute data of the customer (age, sex, address, satisfaction level of a service B, and the like). In a case where the intervention effect calculation is performed using the above Expression (2) according to the present disclosure, it is assumed that each of the confounding variables Z₁ to Z₄ satisfies the backdoor criterion.

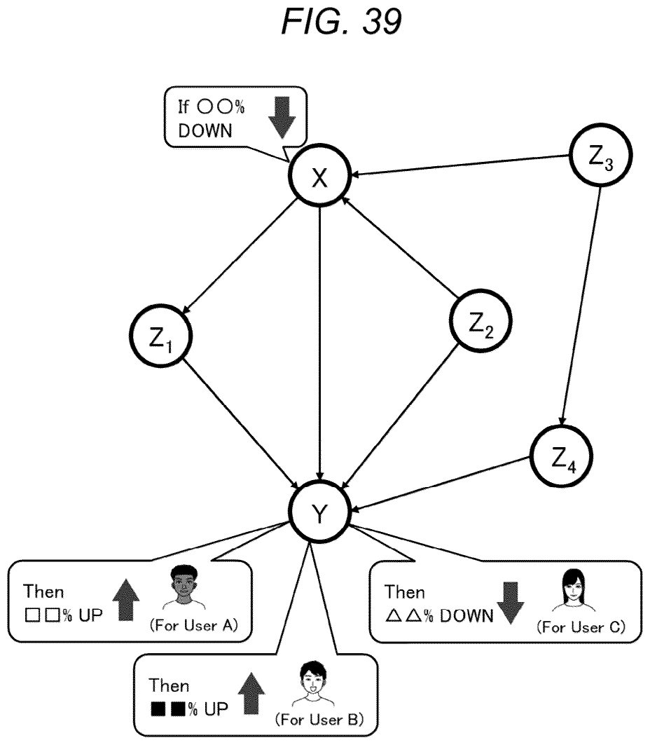

FIG. 38 illustrates the intervention in its entirety. In this case, when the service satisfaction level decreases by ∘∘%, the withdrawal rate increases by □□% over all the customers A to C. On the other hand, FIG. 39 presents results of individual intervention effects calculated separately for each of customer A, customer B, and customer C.

However, the individual intervention effect is not limited to individual data for each customer, and may be a group stratified by confounding variables. Specifically, in a case where the variable Z₁ is an address and the variable Z₂ is a satisfaction level of the service B, the user determines the values of these variables, so that the group of data to be calculated is determined, and the calculation of the individual intervention effect can be performed. For example, when the user determines the value of each variable such as Z₁ (address)=“Kanto” and Z₂ (satisfaction level of service B)=“∘∘%”, calculation of an individual intervention effect for a group of data satisfying Z₁ (address)=“Kanto” & Z₂ (satisfaction level of service B)=“∘∘%” is performed.

As the number of variables in the causal graph increases, the number of variables that should be originally determined by the user increases, which is troublesome for the user. On the other hand, according to the present disclosure, as will be described later in Section E, since the UI for designating the value of the variable for calculating the individual intervention effect is presented by selecting only the variable satisfying the backdoor criterion (in other words, a variable that affects the intervention effect) as an option and limiting to the variable that does not cause data insufficiency, it is possible to greatly reduce the labor on the user side and efficiently implement the intervention effect calculation with high accuracy.

### E. Operation Procedure and UI

An information processing device to which the present disclosure is applied performs UI (user interface) presentation for “causal direction determination” that reduces analysis labor for the user to determine an edge direction when performing processing related to multivariable data analysis, and UI presentation for “search for combination of variables with sufficient data” that prevents deterioration in calculation accuracy due to data shortage at the time of intervention effect calculation. Furthermore, the information processing device to which the present disclosure is applied performs the intervention effect calculation using the item selected by the user via the UI, and details of the calculation method are as described in the above Sections B to D.

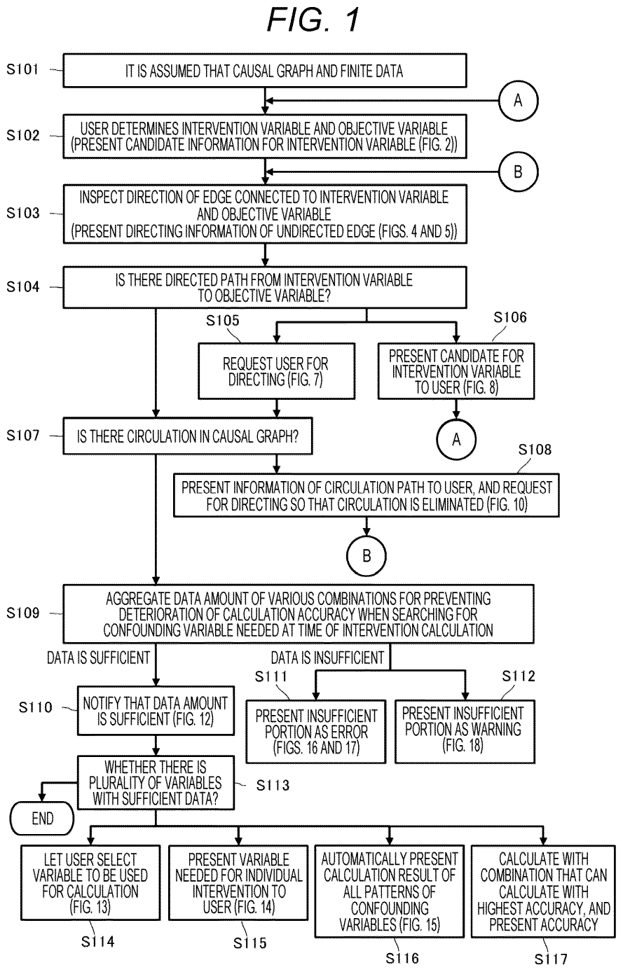

FIG. 1 illustrates a processing procedure performed when an information processing device to which the present disclosure is applied performs processing related to multivariable data analysis in the form of a flowchart.

The information processing device starts processing on the assumption that there is a causal graph including an undirected edge and a directed edge and finite data for each variable in the causal graph (step S101).

Then, the information processing device presents a UI for selecting the intervention variable and the reaction variable from the variables in the causal graph, and causes the user to determine the intervention variable and the reaction variable (step S102). At that time, in a case where there is no directed path from the intervention variable to the reaction variable, a candidate for the intervention variable is presented.

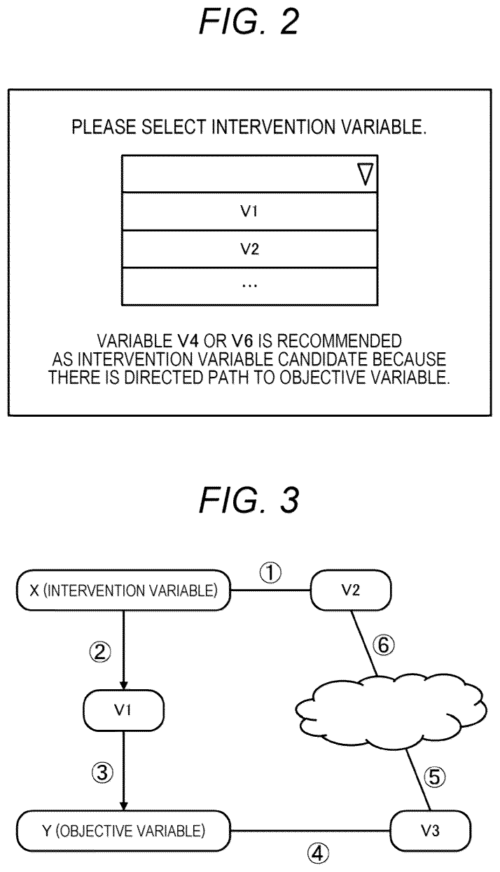

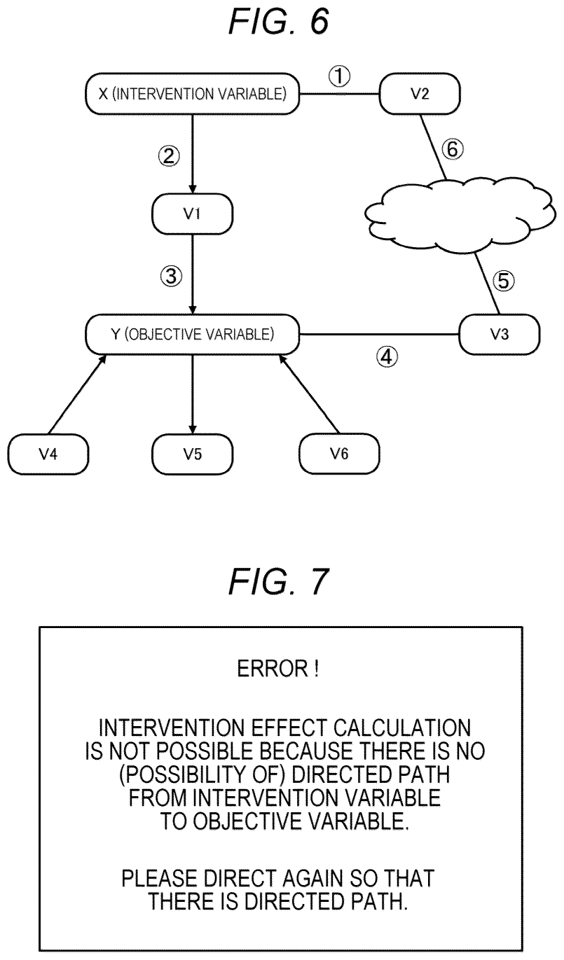

FIG. 2 illustrates a configuration example of a UI screen that presents candidates of an intervention variable. On the illustrated UI screen, one or more variables that are intervention variable selection candidates are displayed in a pull-down manner, and the user can select one of the variables as an intervention variable. Furthermore, in the causal graph illustrated in FIG. 6 (described later), if either a variable V4 or a variable V6 is changed to the intervention variable, a directed path to the reaction variable can be obtained. In such a case, as illustrated in the lower half of the UI screen illustrated in FIG. 2, a message “the variable V4 or V6 is recommended as an intervention variable candidate because there is a directed path to the reaction variable” that recommends selection of a variable candidate having a directed path to a reaction variable may be displayed.

Next, the information processing device checks the direction of the edge adjacent to the intervention variable and the reaction variable, and in a case where the undirected edge is adjacent to at least one of the intervention variable or the reaction variable, the information processing device presents a UI that displays information regarding the edge that needs to be directed or the information regarding the edge that does not need to be directed (step S103), and lets the user to determine the direction of the undirected edge.

FIG. 3 illustrates an example of a causal graph in which an undirected edge is adjacent to an intervention variable and a reaction variable. In the causal graph illustrated in FIG. 3, one edge 1∘ of two edges 1∘ and 2∘ adjacent to the intervention variable X and one edge 4∘ of the two edges 3∘ and 4∘ adjacent to the reaction variable Y are undirected, and it is necessary for the user to determine the direction (however, a circled character of a number such as 3 or 4 is denoted by adding a circle to a number desired to be circled such as “3∘” or “4∘” in the present specification). Here, as described in Section C with reference to FIG. 32, it is sufficient if only the direction of the edge adjacent to the intervention variable X and the reaction variable Y is determined. When the user determines the direction of the undirected edge, the causal graph may be presented to the user on the UI screen. However, variables other than those connected to the edges adjacent to the intervention variable X and the reaction variable Y may be abstracted like a cloud figure, for example, and a simplified causal graph may be presented.

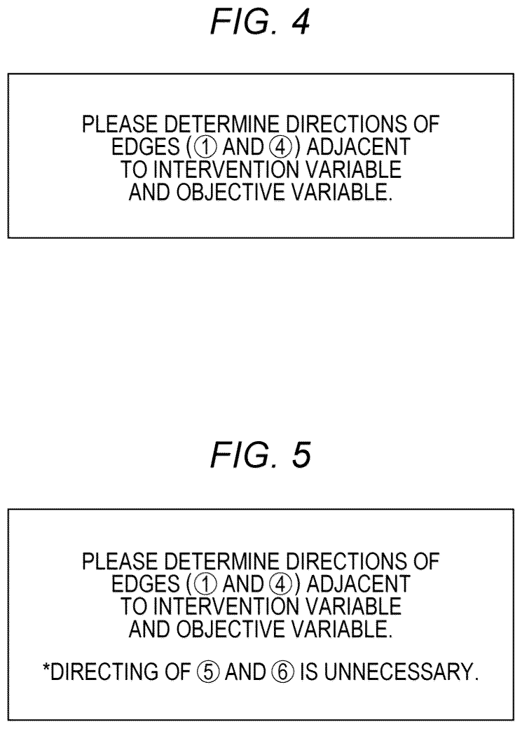

FIG. 4 illustrates a configuration example of a UI screen that displays information of an edge that needs to be directed in the causal graph illustrated in FIG. 3. On the UI screen illustrated in FIG. 4, a message prompting the user to determine the direction of the corresponding undirected edge, such as “please determine direction of edges (1∘ and 4∘) adjacent to intervention variable and reaction variable”, is displayed. Furthermore, FIG. 5 illustrates another configuration example of the UI screen that displays the information of the edge that needs to be directed. On the UI screen illustrated in FIG. 5, in addition to the message similar to the UI screen illustrated in FIG. 4, a message regarding information of an edge that does not need to be directed among edges adjacent to the intervention variable and the reaction variable, such as “directing of 5∘ and 6∘ is unnecessary”, is further displayed. Therefore, the user can easily understand edges other than the target of directing.

Next, the information processing device checks whether or not there is a directed path from the intervention variable to the reaction variable (step S104).

Here, in a case where there is no directed path from the intervention variable to the reaction variable (No in step S140), the information processing device requests the user to perform a procedure for setting a state where there is a directed path from the intervention variable to the reaction variable. Specifically, the processing proceeds to step S105 to request the user to direct the edge again to set the state in which there is a directed path, or the processing proceeds to step S106 to request the user to select the intervention variable in which there is a directed path.

FIG. 6 illustrates an example of a causal graph without a directed path from an intervention variable to a reaction variable. In the illustrated causal graph, in the causal graph illustrated in FIG. 3, the direction from a variable V2 to the intervention variable X is assigned to an undirected edge 10 adjacent to the intervention variable X, and the direction from a variable V3 to the reaction variable Y is assigned to the undirected edge 40 adjacent to the reaction variable Y, but there is no directed path from the intervention variable X to the reaction variable Y. Furthermore, in FIG. 6, variables V4 and V6 connected to the reaction variable Y at a directed edge to the reaction variable Y and a variable V5 at the directed edge from the reaction variable Y (or on the progeny side of the reaction variable Y) are added. In this state, if either the variable V4 or V6 is changed to the intervention variable, a directed path to the reaction variable can be made.

FIG. 7 illustrates a configuration example of a UI screen that requests the user to direct an edge again so that there is a directed path in a case where the process proceeds to step S105. Since a state in which there is no directed path from the intervention variable to the reaction variable is an error state, a warning of “ERROR!/Intervention effect calculation is not possible because there is no (possibility of) directed path from intervention variable to reaction variable” indicating that an error has occurred is displayed on the UI screen illustrated in FIG. 7. Then, a message “please direct again so that there is a directed path” is further displayed to request the user to direct the edge again.

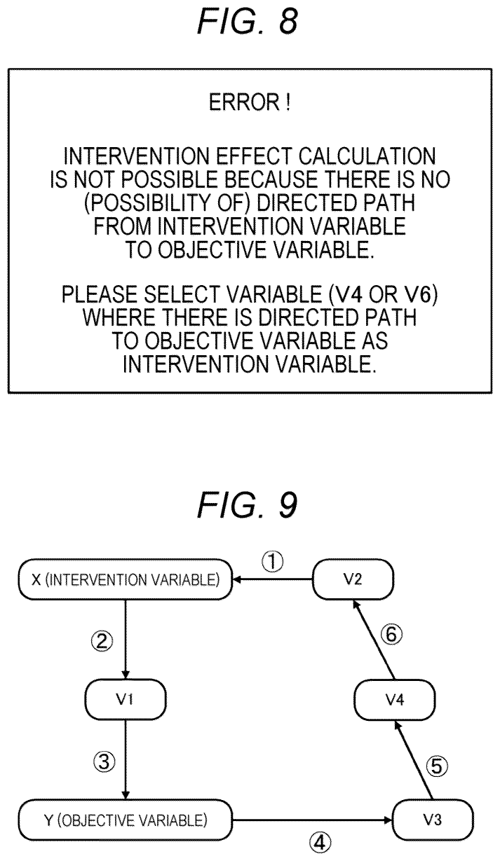

Furthermore, FIG. 8 illustrates a configuration example of a UI screen for prompting the user to select an intervention variable having a directed path in a case where the process proceeds to step S106. The UI screen illustrated in FIG. 8 also displays a warning “ERROR!/Intervention effect calculation is not possible because there is no directed path from intervention variable to reaction variable” indicating that an error has occurred. Furthermore, in the state illustrated in FIG. 6, if either the variable V4 or the variable V6 is changed to the intervention variable, a directed path to the reaction variable can be obtained. Accordingly, V4 and V6 are explicitly indicated as candidates of the intervention variable, a message “please select the variable (V4 or V6) where there is a directed path to the response variable as the intervention variable” is displayed, and the user is requested to reselect one of the candidates of the intervention variable having the directed path.

On the other hand, in a case where there is a directed path from the intervention variable to the reaction variable (Yes in step S104), and after the directed path from the intervention variable to the reaction variable is formed by the processing in step S105, the information processing device checks whether there is a circulation in the causal graph (step S107). Furthermore, in a case where the intervention variable in which the directed path exists is selected by the user in the processing of step S106, the processing returns to step S102, and the information processing device repeatedly executes the above processing.

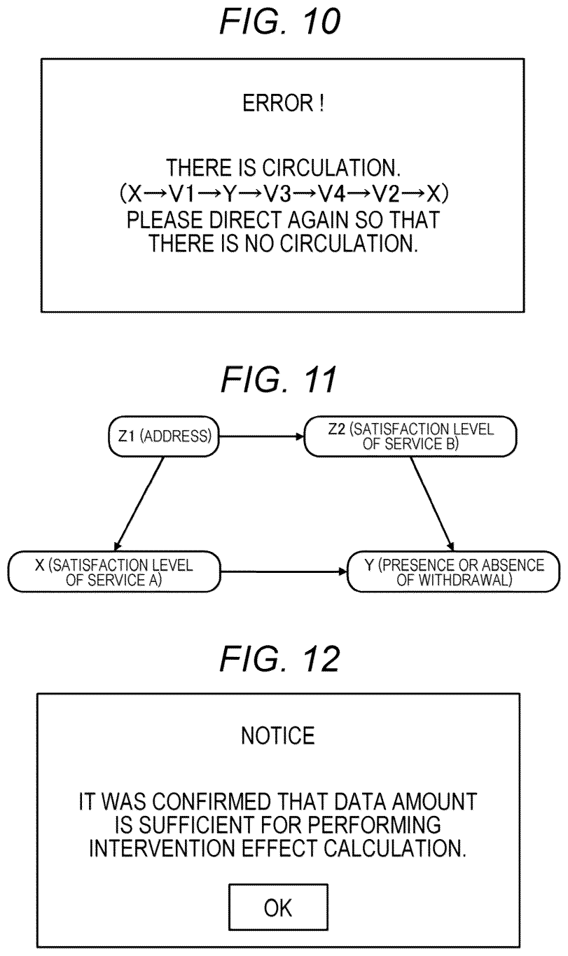

FIG. 9 illustrates an example of a causal graph in which circulation occurs. In the illustrated example, a circulation of X→V1→Y→V3→V4→V2→X occurs. The circulation is an error. Accordingly, in a case where there is a circulation in the causal graph (No in step S107), the information processing device presents a UI that notifies of an error and requests the directing of the edge to resolve the requested circulation (step S108). FIG. 10 illustrates a configuration example of a UI screen that notifies of an error and requests directing of the edge so as to resolve the requested circulation. On the UI screen illustrated in FIG. 10, an error message “ERROR!” is displayed together with a message such as “there is a circulation (X→V1→Y→V3→V4→V2→X). Please direct again so that there is no circulation” to request the user to direct the edge to eliminate the circulation. After the directing of the edge is performed again by the user in step S108, the processing returns to step S103, and the information processing device repeatedly executes the above processing.

Through the above processing, when the directions of all the edges adjacent to the intervention variable and the reaction variable are determined and a causal graph with no error (that is, there is a directed path from the intervention variable to the reaction variable, and no circulation has occurred) can be obtained, the intervention effect can be calculated using only the variable satisfying the backdoor criterion according to the above Expression (2). Although not illustrated in FIG. 1, it is assumed that the information processing device extracts a variable (confounding variable) satisfying the backdoor criterion from the causal graph before starting the intervention calculation when the directions of all the edges adjacent to the intervention variable and the reaction variable are determined and a causal graph with no error is obtained.

The information processing device searches for the confounding variable to be used for the intervention effect calculation on the basis of a result of aggregating the amount of data of a combination of the value of the intervention variable and the value of the confounding variable (step S109). Then, it is checked whether or not there is a sufficient amount of data for calculating the intervention effect with high accuracy as a result of aggregating the amount of data of various combinations.

Note that, in the intervention effect calculation phase after step S109, a specific configuration of the UI screen will be described using a simple causal graph as illustrated in FIG. 11 as an example. The illustrated causal graph is an example of data analysis in a certain company engaged in a service industry, in which the “satisfaction level of service A” of the customer is the intervention variable X, the “presence or absence of withdrawal” of the customer is the reaction variable Y, and Z1 (address) and Z2 (satisfaction level of service B) are included as confounding variables (satisfying the backdoor criterion), and the directions of all edges adjacent to the intervention variable X and the reaction variable Y are determined.

In a case where it has been found in step S109 that there is a sufficient amount of data for calculating the intervention effect with high accuracy as a result of aggregation of the data amounts of various combinations, the information processing device presents a UI notifying that there is sufficient data for calculating the intervention effect with high accuracy (step S110).

FIG. 12 illustrates a configuration example of a UI screen notifying that the amount of data sufficient to calculate the intervention effect with high accuracy is sufficient in step S110. On the UI screen illustrated in FIG. 12, a message notifying that there is sufficient data, such as “It was confirmed that the amount of data is sufficient for performing the intervention effect calculation”, is displayed, and when the user presses the “OK” button to confirm the message, the process proceeds to the subsequent intervention effect calculation process.

Next, the information processing device searches the causal graph for a confounding variable in which the data amount of the combination with each value of the intervention variable is sufficient, and checks whether there is a plurality of such confounding variables (step S113). However, since only the variables satisfying the backdoor criterion among the confounding variables in the causal graph are used for the intervention effect calculation, only the confounding variables satisfying the backdoor criterion are searched for in step S113.

In step S113, in a case where there is only one confounding variable in which the data amount of the combination with each value of the intervention variable is sufficient, the information processing device performs the intervention effect calculation using the only confounding variable in which the data amount is sufficient, and ends the present processing.

Furthermore, in step S113, in a case where a plurality of confounding variables having a sufficient data amount of the combination with each value of the intervention variable is found, the information processing device proceeds to any one of steps S114 to S117, and performs the intervention effect calculation using any confounding variable having a sufficient data amount. A method for the information processing device to determine which processing to proceed in steps S114 to S117 is arbitrary. The information processing device may perform automatic selection or may follow the user's selection. Hereinafter, the processing performed in each step S114 to 117 and the UI screen presented to the user will be described.

First, the processing performed in step S114 will be described. In step S114, the user is allowed to select which one of the plurality of confounding variables having a sufficient amount of data in combination with each value of the intervention variable is used for the intervention effect calculation.

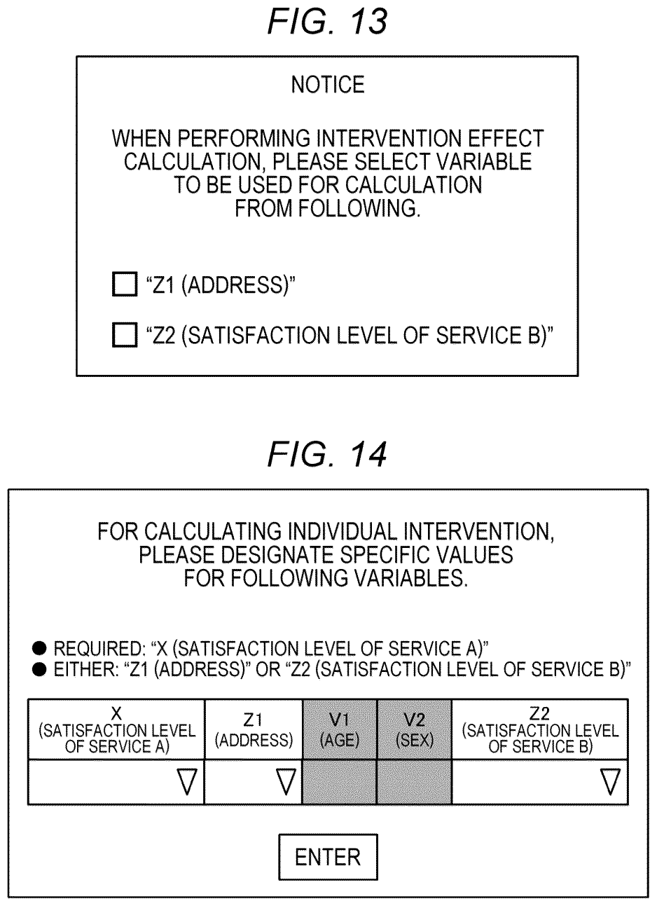

FIG. 13 illustrates a configuration example of a UI screen for allowing the user to select which variable is used for the intervention effect calculation in step S114. Here, the causal graph illustrated in FIG. 11 is assumed, and it is assumed that the data amount of the combination of the two confounding variables Z1 (address) and Z2 (satisfaction level of service B) with each value of the intervention variable is sufficient. On the UI screen illustrated in FIG. 13, each variable candidate is listed, and a message “for performing the intervention effect calculation, please select variable to be used for the calculation from the following” prompting variable selection is displayed. Then, the user can select a variable desired to be used for the intervention effect calculation by checking a check box. The user can select one or both of the variables Z1 and Z2 via the UI screen illustrated in FIG. 13. In a case where only Z1 is selected, the information processing device performs intervention effect calculation using the following Expression (3). Furthermore, in a case where Z1 and Z2 are selected, the information processing device performs intervention effect calculation using the following Expression (4).

$$\begin{matrix}[ Math . 3 ] & \\ f ( y \vert set ( X = x ) ) = \int {f}_{Z} ( {z}_{1} ) {f}_{Y \cdot X Z} ( y \vert x , {z}_{1} ) {dz}_{1} & ( 3 )\end{matrix}$$

$$\begin{matrix}[ Math . 4 ] & \\ f ( y \vert set ( X = x ) ) = \int \int {f}_{Z} ( {z}_{1} , {z}_{2} ) {f}_{Y \cdot X Z} ( y \vert x , {z}_{1} , {z}_{2} ) {dz}_{1} {dz}_{2} & ( 4 )\end{matrix}$$

Next, processing performed in step S115 will be described. In step S115, in a case where there is a plurality of sufficient confounding variables in the data amount of the combination with each value of the intervention variable, a variable necessary to be input for calculating the individual intervention effect is presented to the user, and input or selection of the value of the confounding variable is urged.

FIG. 14 illustrates a configuration example of a UI screen that presents variables that need to be input for performing the individual intervention effect to the user in step S115. Here, the causal graph illustrated in FIG. 11 is assumed, and it is assumed that the data amount of the combination of the two confounding variables Z1 (address) and Z2 (satisfaction level of service B) with each value of the intervention variable is sufficient. On the UI screen illustrated in FIG. 14, it is clearly indicated that the input of intervention variable X (the satisfaction level of service A) is required and that which one of two confounding variables Z1 (address) and Z2 (the satisfaction level of service B) is input is arbitrary, and a message “for calculating the individual intervention effect, please designate specific values for the following variables” prompting the input of the value of each variable is displayed.

Moreover, a table for designating a value of each variable in the causal graph is arranged on the UI screen. In this table, pull-down menus are prepared for each cell of intervention variable X (satisfaction level of service A) for which input of a value is required, and two confounding variables Z1 (address) and Z2 (satisfaction level of service B). Pressing the “∇” button on the right side of the cell causes a pull-down menu to appear, and the user can designate the value of the corresponding variable by selecting a desired value in the menu. Although not illustrated, the pull-down menu of the confounding variable Z1 (address) includes, for example, values such as “Kanto”, “Kinki”, and “Shikoku”, and the user can select any one of these values from the pull-down menu. Then, when the user presses the “enter” button after designating the value of the desired variable, the selected value is determined, and the information processing device executes the calculation of the individual intervention effect.

Furthermore, the table in the UI screen illustrated in FIG. 14 also includes columns of other variables V1 (age) and V2 (sex) in the causal graph. Since these variables V1 (age) and V2 (gender) do not satisfy the backdoor criterion and do not affect the intervention effect calculation even if any value is designated, that is, it is not necessary to designate a value in calculating the individual intervention effect, these cells are inactive (gray display in FIG. 14) in the table, which indicates that the user does not need to determine the value of the variable.

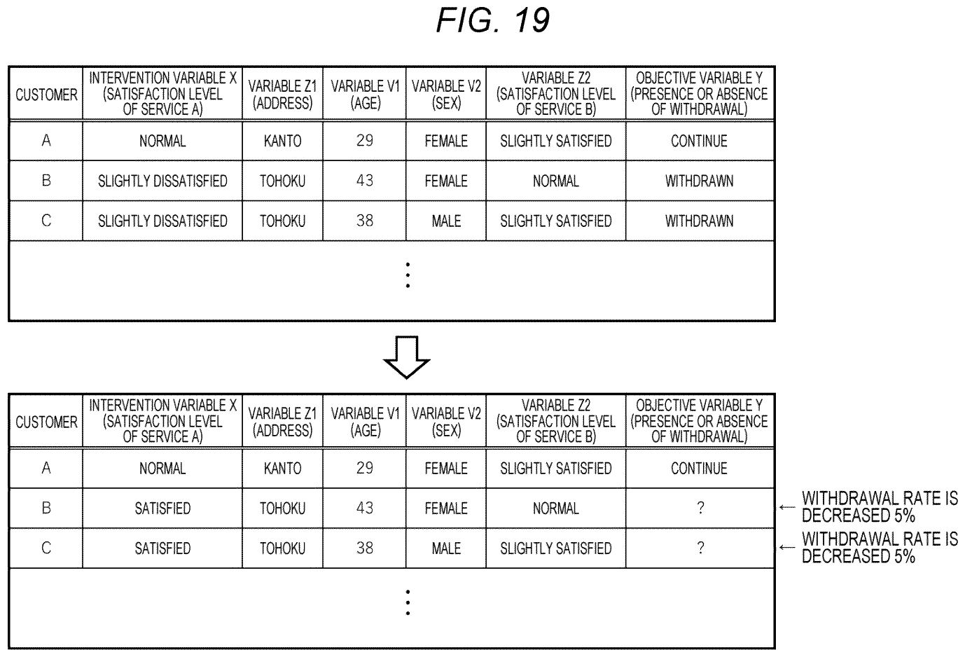

The user can designate the group unit to be stratified by selecting the value of the variable in at least one of the cells of the variable Z1 (address) and the variable Z2 (satisfaction level of the service B) actively displayed in the table in the UI screen illustrated in FIG. 14. Furthermore, the user can obtain information that results of the intervention effect calculation match in the group. This point will be supplementarily described with reference to FIG. 19. In a case where it is desired to calculate the influence on the reaction variable Y (the presence or absence of a tournament), that is, the individual intervention effect in a case where the intervention variable X (the satisfaction level of the service A) of the customer B is changed from “slightly dissatisfied” to “satisfied”, it is possible to obtain information that the intervention effect calculation is the same (the withdrawal rate is decreased by 5%) for the group (Customer B, customer C, . . . in the same drawing) of the confounding variable Z1 (address)=“TOHOKU”. Therefore, when the customer is Z1 (address)=“TOHOKU”, regardless of the variable V1 (age) and the variable V2 (sex), the influence on the reaction variable Y when the intervention variable X changes (the effect on the withdrawal rate when the satisfaction level of the service A increases) is the same. Therefore, it can be said that it is not necessary to designate the values of the variables V1 (age) and V2 (sex).

Next, processing performed in step S116 will be described. In step S116, in a case where there is a plurality of sufficient confounding variables in the data amount of the combination with each value of the intervention variable, each intervention effect calculation is performed in parallel after automatically stratifying with each value of the confounding variables, and the result is presented to the user.

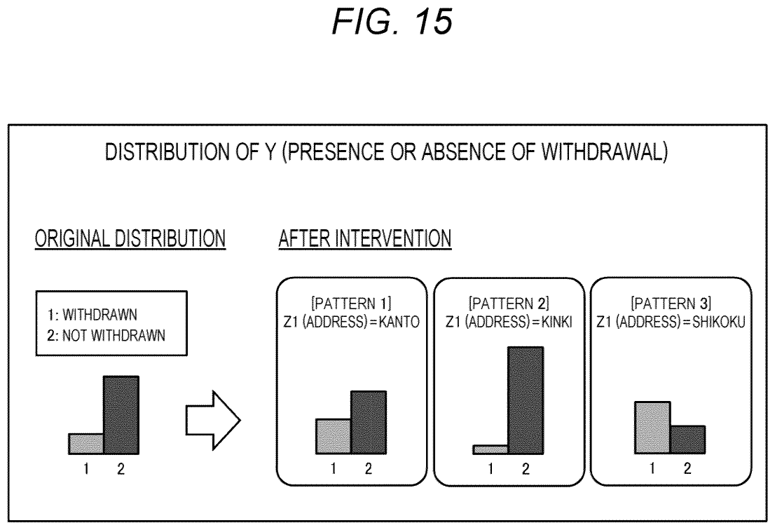

FIG. 15 illustrates a configuration example of a UI screen that automatically presents the result of performing the intervention effect calculation on all the values of the confounding variables to the user in step S116. On the UI screen illustrated in FIG. 15, one variable Z1 (address) of two confounding variables Z1 (address) and Z2 (satisfaction level of service B) is automatically selected, and the distribution of “1: withdrawn” and “2: not withdrawn” for the result (that is, the addresses “Kanto”, “Kinki,” and “Shikoku”) of “after intervention” in which the individual intervention effect is calculated after stratification with each value “Kanto”, “Kansai”, and “Shikoku” of the variable Z1 (address) is displayed together with the original distribution (that is, the distribution of “1: withdrawn” and “2: not withdrawn” as a whole, which is not stratified for each address).

Next, processing performed in step S117 will be described. In step S117, in a case where there is a plurality of confounding variables in which the data amount of the combination with each value of the intervention variable is sufficient, the information processing device performs the intervention effect calculation using the combination of the value of the intervention variable X and the value of the confounding variable with which the most accurate calculation can be performed. It can be said that the most accurate calculation can be performed by the combination of the value of the intervention variable X and the value of the confounding variable having the largest data amount. Furthermore, the information processing device may present the index value regarding accuracy to the user when performing such calculation.

On the other hand, in a case where it is found in step S109 that the data for calculating the intervention effect with high accuracy is not sufficient, the information processing device presents a UI for notifying of a portion where the combination of the data is insufficient as an error (step S111) or presents a UI for notifying of a portion where the combination of the data is insufficient as a warning (step S112).

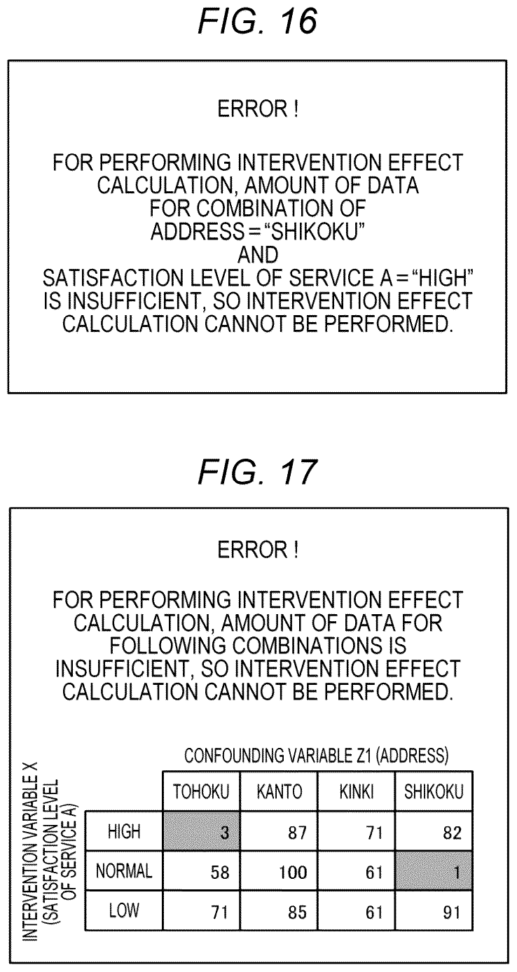

FIG. 16 illustrates a configuration example of a UI screen that notifies of a portion where the combination of data is insufficient as an error in step S111. It is assumed that the causal graph illustrated in FIG. 11 is assumed, and the data amount of the combination of the intervention variable X (the satisfaction level of service A)=“high” and the confounding variable Z1 (address)=“Shikoku” is insufficient. On the UI screen illustrated in FIG. 16, an error display of “ERROR!” is displayed, and information of a portion having an insufficient data amount of “for performing the intervention effect calculation, the amount of data for the combination of address=“Shikoku” and satisfaction level of service A=“high” is insufficient, so the intervention effect calculation cannot be performed” is also displayed.

FIG. 17 illustrates another configuration example of the UI screen that notifies of a portion where the combination of data is insufficient as an error in step S111. On the UI screen illustrated in FIG. 17, after an error display of “ERROR!” and a message of “for performing the intervention effect calculation, the amount of data for the following combinations is insufficient, so the intervention effect calculation cannot be performed”, a portion where the data amount is insufficient is illustrated in a heat map format on a table displaying a list of combinations of values of the variables. Specifically, each value (“high”, “normal”, “low”) of the intervention variable X (the satisfaction level of the service A) is allocated to each row of the table, each value (“Tohoku”, “Kanto”, “Kinki”, and “Shikoku”) of the confounding variable Z1 (address), which is a problem of insufficient data amount, is allocated to each column of the table, and the data amount of the combination of the values corresponding to the intervention variable X and the confounding variable Z1 is filled in each cell of the table to display a list. Then, the cell (cell corresponding to the combination of “high” and “TOHOKU” and the combination of “ordinary” and “Shikoku”) corresponding to the combination of the values of the variables in which the insufficient data amount is a problem is highlighted (In FIG. 17, gray display). Therefore, the user can easily find a portion where the data amount is insufficient from the UI screen illustrated in FIG. 17. Furthermore, as compared with the case where the corresponding part is indicated by pinpoint as illustrated in FIG. 16, the combination of the values of the variables can be understood by the user in an overhead view by indicating the corresponding part in a heat map format as illustrated in FIG. 17.

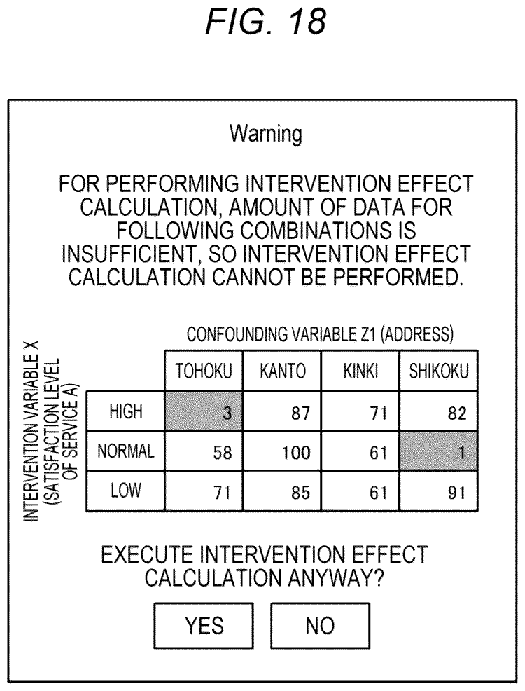

Furthermore, FIG. 18 illustrates a configuration example of a UI screen that notifies of a portion where the combination of data is insufficient as a warning in step S112. On the UI screen illustrated in FIG. 18, after the warning of “warning” is displayed, similarly to the UI screen of the error display illustrated in FIG. 17, a portion where the data amount is insufficient is indicated in a heat map format on a table displaying a list of combinations of values of the variables together with a message of “when performing the intervention effect calculation, the amount of data for the following combinations is insufficient, so the intervention effect calculation cannot be performed”. Similarly to the UI screen illustrated in FIG. 17, since the cells corresponding to the combination of the values of the variables in which the insufficient amount of data is a problem are illustrated in the heat map format, the user can understand the combination of the values of the variables in an overhead view, and can easily find the place where the amount of data is insufficient. However, unlike the UI screen of the error display illustrated in FIG. 17, the warning UI screen illustrated in FIG. 18 displays a message inquiring the user that “execute intervention effect calculation anyway?”, and arranges a “Yes” button and a “No” button. If the user presses the “No” button, the information processing device does not execute the intervention effect calculation, but if the user presses the “Yes” button and accepts that the calculation accuracy is deteriorated due to the lack of data, the information processing device executes the intervention effect calculation as it is. In such a case, the information processing device may present the index value regarding the accuracy to the user together with the calculation result.

### F. Device Configuration

In this Section F, an information processing device that performs intervention effect calculation and presentation of a UI screen in accordance with the operation procedure as described in Section E above will be described.

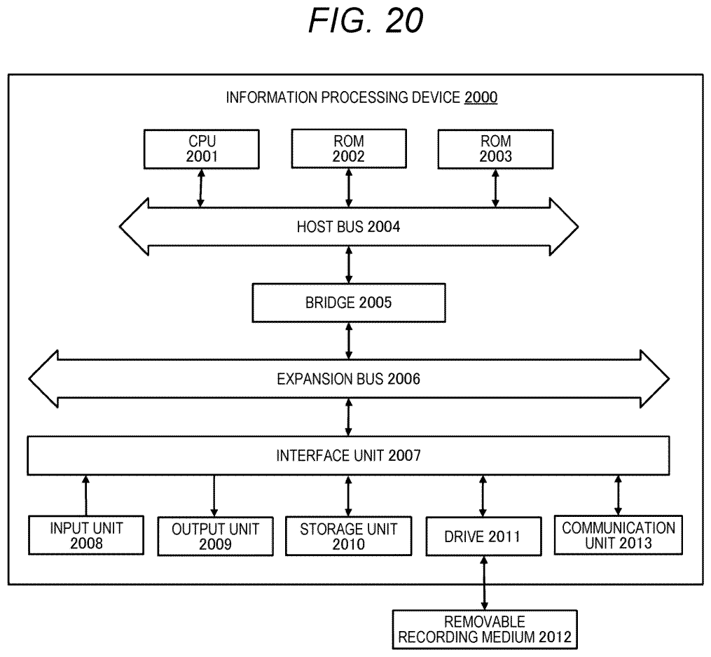

FIG. 20 illustrates a configuration example of an information processing device 2000 that performs intervention effect calculation and presentation of a UI screen. The information processing device 2000 includes a central processing unit (CPU) 2001, a read only memory (ROM) 2002, a random access memory (RAM) 2003, a host bus 2004, a bridge 2005, an expansion bus 2006, an interface unit 2007, an input unit 2008, an output unit 2009, a storage unit 2010, a drive 2011, and a communication unit 2013.

The CPU 2001 functions as an arithmetic processing device and a control device, and controls the overall operation of the information processing device 2000 according to various programs. The ROM 2002 stores programs (a basic input/output system, or the like) and calculation parameters used by the CPU 2001 in a nonvolatile manner. The RAM 2003 is used to load a program to be used in execution of the CPU 2001 and temporarily store parameters such as work data that appropriately changes during program execution. Examples of the program loaded into the RAM 2003 and executed by the CPU 2001 include various application programs, an operating system (OS), and the like.

The CPU 2001, the ROM 2002, and the RAM 2003 are interconnected by the host bus 2004 including a CPU bus or the like. Then, the CPU 2001 operates in conjunction with the ROM 2002 and the RAM 2003 to execute various application programs under the execution environment provided by the OS, thereby enabling various functions and services to be implemented. In a case where the information processing device 2000 is a personal computer (PC), the OS is, for example, Windows or Unix of Microsoft Corporation. Further, in a case where the information processing device 2000 is a smartphone or a tablet, the OS is, for example, iOS of Apple Inc. or Android of Google Inc. Furthermore, the application program includes a causal inference application (provisional name) and an intervention effect calculation application (provisional name) for performing multivariable data analysis based on the present disclosure.

The host bus 2004 is connected to the expansion bus 2006 via the bridge 2005. The expansion bus 2006 is, for example, a peripheral component interconnect (PCI) bus or PCI Express, and the bridge 2005 is based on the PCI standard. However, the information processing device 2000 does not necessarily have a configuration in which circuit components are separated by the host bus 2004, the bridge 2005, and the expansion bus 2006, and thus may be configured in such a way that almost all circuit components are implemented by being interconnected using a single bus (not illustrated).

The interface unit 2007 connects peripheral devices such as the input unit 2008, the output unit 2009, the storage unit 2010, the drive 2011, and the communication unit 2013 according to the standard of the expansion bus 2006. However, all of the peripheral devices illustrated in FIG. 20 are not necessarily essential, and the information processing device 2000 may further include a peripheral device (not illustrated). Furthermore, the peripheral device may be built in the main body of the information processing device 2000, or some peripheral devices may be externally connected to the main body of the information processing device 2000.

The input unit 2008 includes an input control circuit that generates an input signal on the basis of an input from a user and outputs the input signal to the CPU 2001, and the like. In a case where the information processing device 2000 is a PC, the input unit 2008 may include a keyboard, a mouse, and a touch panel, and may further include a camera and a microphone. Furthermore, in a case where the information processing device 2000 is an information terminal such as a smartphone or a tablet, the input unit 2008 is, for example, a touch panel, a camera, or a microphone, and may further include another mechanical operator such as a button. As in the present embodiment, in a case where causal inference and intervention effect calculation are performed on the information processing device 2000, the input unit 2008 is used for user input operations such as directing of an edge in a causal graph, selection of an intervention variable, and designation of a value of a variable.

The output unit 2009 includes, for example, a display device such as a liquid crystal display (LCD) device, an organic electro-luminescence (EL) display device, and a light emitting diode (LED). As in the present embodiment, in a case where causal inference and intervention effect calculation are performed on the information processing device 2000, a UI screen (described above) for performing input operation (directing of an edge in the causal graph, selection of an intervention variable, designation of a value of a variable, and the like), presentation of messages and calculation results, and the like is performed using a display device. Furthermore, the output unit 2009 may include an audio output device such as a speaker and a headphone, and output at least a part of a message to the user displayed on the UI screen as an audio message.

The storage unit 2010 stores files such as programs (application, OS, or the like) to be executed by the CPU 2001 and various pieces of data. Data stored in the storage unit 2010 may include a database (described later) of attribute data for data analysis. Although the storage unit 2010 includes, for example, a mass storage device such as a solid state drive (SSD) or a hard disk drive (HDD), the storage unit 2010 may include an external storage device.

A removable recording medium 2012 is a cartridge-type recording medium such as a microSD card, for example. The drive 2011 performs reading and writing operations on a removable storage medium 113 loaded therein. The drive 2011 outputs data read from the removable recording medium 2012 to the RAM 2003 and the storage unit 2010, and writes data on the RAM 2003 and the storage unit 2010 to the removable recording medium 2012.

The communication unit 2013 is a device that performs wireless communication such as Wi-Fi (registered trademark), Bluetooth (registered trademark), or a cellular communication network such as 4G or 5G. Furthermore, the communication unit 2013 also include a terminal such as a universal serial bus (USB) or a high-definition multimedia interface (HDMI) (registered trademark), and may further include a function of performing HDMI (registered trademark) communication with a USB device such as a scanner or a printer, a display, or the like.

Although a PC is assumed as the information processing device 2000, it is not limited to one device, and the processing of each step illustrated in FIG. 1 can be executed in a distributed manner to two or more devices.

Furthermore, information presentation to the user and, input operation of the user such as designation of a variable and a value of a variable can be performed by an information terminal such as a smartphone or a tablet, input data can be transferred from the information terminal to the information processing device 2000, and high-load processing such as causal inference and intervention effect calculation can be performed by the information processing device 2000.

Furthermore, a database of attribute data (data of each variable) used for data analysis may be stored in an external data server, and the information processing device 2000 may make an inquiry to the data server and execute the intervention effect calculation while reading necessary data.

### G. Example (1)

In this Section G, an embodiment of the present disclosure applied to data analysis in a company that develops a service industry will be described.

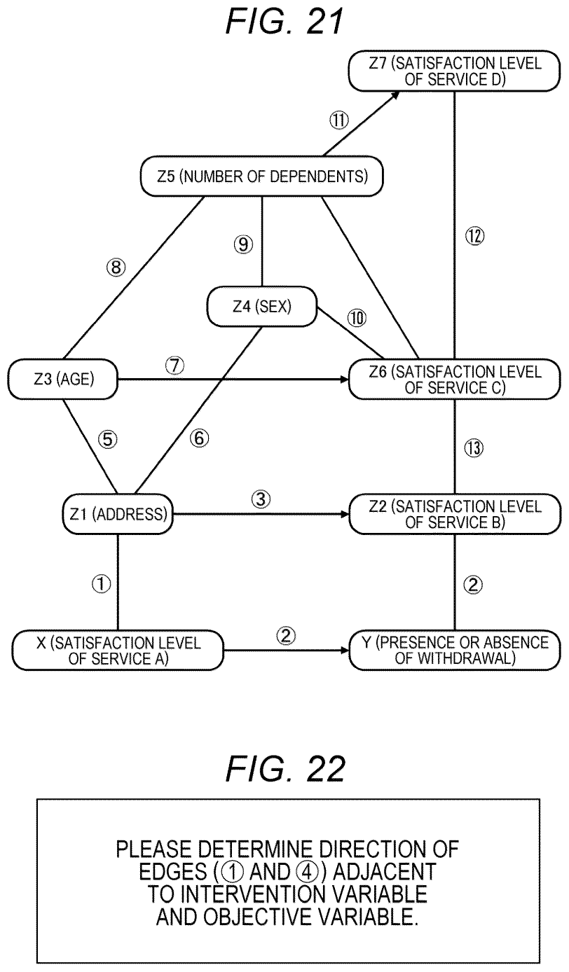

Furthermore, it is assumed that a company has attribute data such as an age, a gender, and an address of a customer in a database, and also has questionnaire data performed for each customer in a form associated therewith. It is assumed that a causal graph representing a causal relationship between variables (see FIG. 21) is obtained from the data by performing analysis to infer a causal relationship to find the cause in order to reduce the ratio of people who leave the contract using this data. Such a causal graph may be created according to a predetermined causal inference algorithm, or may be created on the basis of human knowledge. The causal graph includes a plurality of variables and directed or undirected edges connecting the variables, but it is assumed that a causal relationship between some variables is unknown (Here, a case is assumed in which connection is known but the direction of cause and effect is unknown). Then, by intervening in a variable located upstream of a variable indicating the presence or absence of withdrawal, an intervention effect calculation is performed so that it is desired to lower the withdrawal rate.

For example, it is assumed that the influence on the reaction variable Y (presence or absence of withdrawal) variable is viewed by intervening in the intervention variable X (satisfaction level of service A) variable. At that time, in order for the user to decide only the causal direction around each of the intervention variable X and the reaction variable Y, the information processing device 2000 presents a UI that displays information regarding an edge that needs to be directed or a UI that displays information regarding an edge that does not need to be directed.

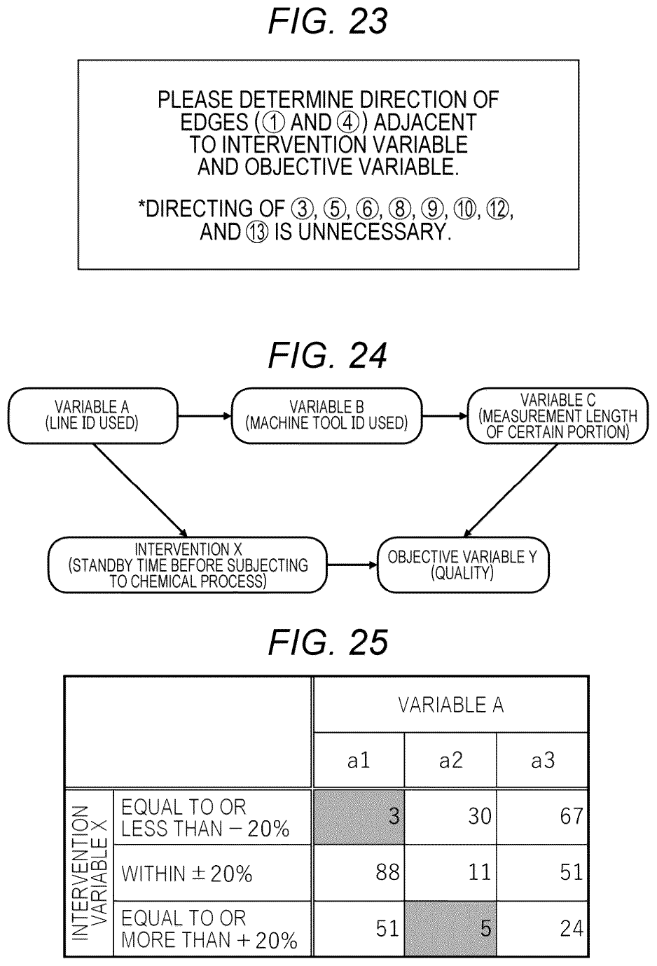

FIG. 22 illustrates a UI screen that displays information on an edge that needs to be directed in the causal graph illustrated in FIG. 21. Furthermore, FIG. 23 illustrates a UI screen that displays information regarding edges that do not need to be directed (5∘, 6∘, 8∘, 9∘, 10∘, 12∘, 13∘) together with the edges that need to be directed (1∘ and 4∘). Since the causal graph illustrated in FIG. 21 includes many (10) undirected edges, it takes a lot of trouble for the user to determine the complete causal relationship (that is, directions of all edges) between variables. On the other hand, according to the present disclosure, only the direction of the edge adjacent to each of the intervention variable X and the reaction variable Y is determined, and the intervention effect calculation is performed according to the above Expression (2) using the confounding variable satisfying the backdoor criterion. Therefore, among the 10 undirected edges in the causal graph illustrated in FIG. 21, it is only necessary to determine the directions of the two edges 1∘ and 4∘ adjacent to the intervention variable X or the reaction variable Y, and thus, it is possible to greatly reduce the labor of the user.

Furthermore, in the causal graph illustrated in FIG. 21, even if the user is requested to direct the edge (12∘ in the drawing) between “Z6 (the satisfaction level of the service C)” and “Z7 (the satisfaction level of the service D)”, the user may be confused (the correct answer is not known). On the other hand, according to the present disclosure, it is not necessary to direct the edge 12∘ that is not adjacent to any of the intervention variable X and the reaction variable Y, and the UI screens illustrated in FIGS. 22 and 23 do not prompt the direction of the edge 120, so that the user's confusion can be prevented.

For convenience of paper, as Example (1), an example in which directing of 10 undirected edges can be reduced to 2 edges is illustrated using FIGS. 21 to 23. In the case of causal graphs in which the number of variables exceeds one hundred, several hundred undirected edges may be included, but according to the present disclosure, reduction to directions of several undirected edges respectively adjacent to the intervention variable X and the reaction variable Y is possible. That is, according to the present disclosure, it is also possible to solve the problem that the number of undirected edges to be directed is too large (it takes too much time and effort) to reach the intervention effect calculation.

### H. Example (2)

In this Section H, an example of the present disclosure applied to data analysis in a company operating a manufacturing industry will be described. In the embodiment (2), portions corresponding to the processing after step S109 of the flowchart illustrated in FIG. 1 will be mainly described.

This company has a factory that manufactures industrial parts produced through chemical processes and machining processes, and holds data for production management and stores the data in a database. It is assumed that the database includes various observation data associated with the manufactured product ID of the industrial parts. It is assumed that a causal graph indicating a causal relationship between variables as illustrated in FIG. 24 is obtained including a case where an analysis to find factors affecting the product yield is performed using this data, and creation, supplementation, supplementation, and correction are performed with human domain knowledge.

The causal graph illustrated in FIG. 24 is a state in which the directions of all the edges adjacent to the intervention variable X and the reaction variable Y are determined and there is no error. Then, an intervention effect calculation is performed in which it is desired to increase a yield rate of a product by intervening in a variable estimated or determined as a direct or indirect cause of a variable indicating quality of the product. Here, it is assumed that the deviation of the “length of waiting time before chemical process input” (hereinafter, this variable is referred to as an intervention variable X) from the standard setting value adversely affects the quality (hereinafter, this variable is referred to as a reaction variable Y).

The causal graph illustrated in FIG. 24 is obtained by cutting out only a portion related to a variable (variable A, variable B, variable C) necessary for intervention effect calculation from the causal graph in which various observation data are represented by each node. The variable A, the variable B, and the variable C are all confounding variables (satisfying the backdoor criterion), and any of them may be used for the intervention calculation as long as the amount of data is infinite. However, in practice, there is a possibility that the amount of data of the combination of the specific values of the variables A to C and the specific value of the intervention variable X is insufficient. Therefore, the information processing device 2000 aggregates all combinations of the values of the variables A to C and the values of the intervention variable X by the background processing, and confirms excess or deficiency of the data amount for each combination. Then, as illustrated in FIGS. 25 to 27, a UI screen is presented in which a portion where the data amount is insufficient on a table displaying a list of combinations of the values of the variables is displayed in a heat map format.

In the table of FIG. 25, the data amount of the combination of each value of variable A and intervention variable X is illustrated. In this example, the number of pieces of data of the combination of “variable A=a1” and “intervention variable X=time length of −20% or less of the standard value” is 3, and the number of pieces of data of the combination of “variable A=a2” and “intervention variable X=time length of +20% or more of the standard value” is 5, and it is obvious that the data amount is insufficient, and it is considered that the accuracy is statistically deteriorated when the intervention effect calculation is performed using the variable A. On the table illustrated in FIG. 25, cells corresponding to a combination of variables having an insufficient data amount are illustrated in a heat map format.

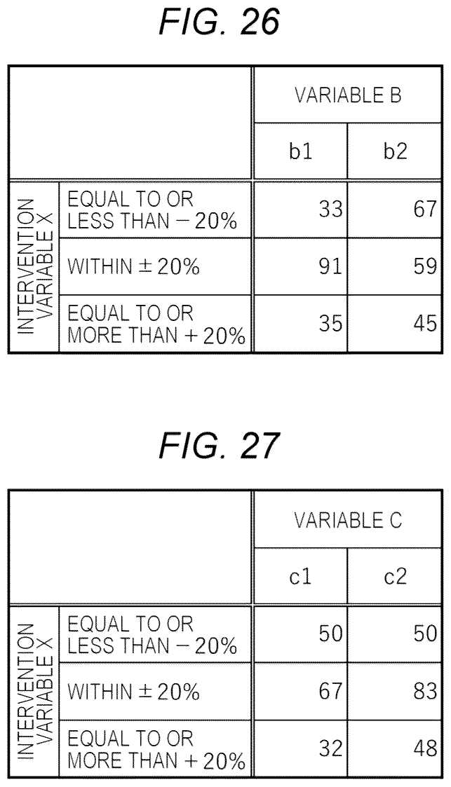

On the other hand, in the table of FIG. 26, the data amount of the combination of the values of variable B and intervention variable X is illustrated, but there are 33 combinations of the values of the variable having the lowest data amount. Furthermore, in the table of FIG. 27, the data amount of the combination of the values of variable C and intervention variable X is illustrated, but the number of combinations of the values of the variable having the lowest data amount is 32. Therefore, both the variable B and the variable C have a larger data amount than the variable A, and the accuracy is maintained as compared with the case of performing the intervention effect calculation using the variable A.

Therefore, the information processing device 2000 performs processing corresponding to any one of steps S114 to S117 in the flowchart illustrated in FIG. 1 assuming that there are a plurality of candidates for the confounding variable in the intervention effect calculation for the variable B and the variable C.

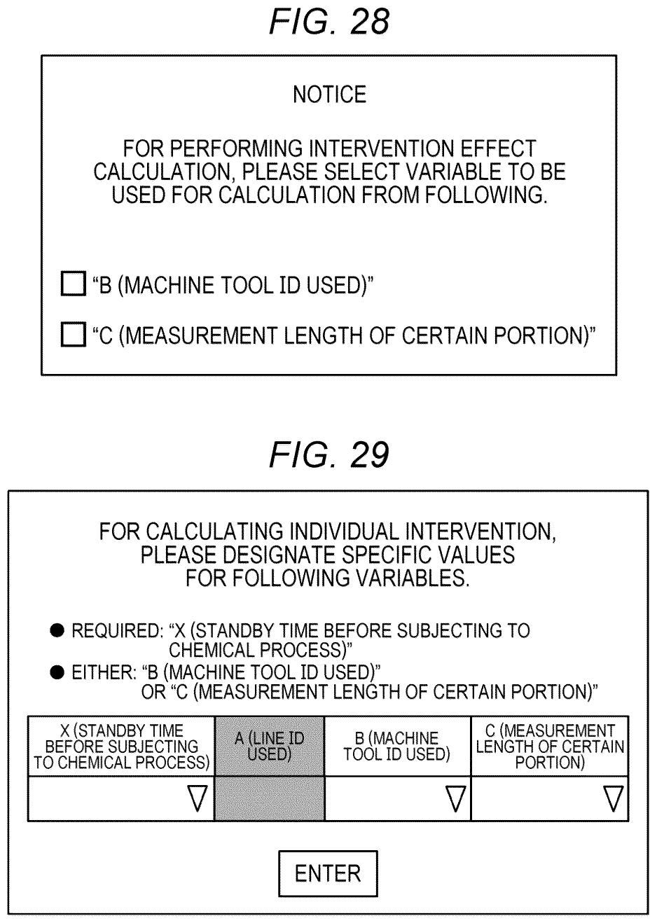

Specifically, as the processing in step S114, the information processing device 2000 presents a UI screen as illustrated in FIG. 28 and allows the user to select which one of the variable B and the variable C is used for the intervention effect calculation.

Furthermore, as the processing of step S115, the information processing device 2000 presents the UI screen as illustrated in FIG. 29, presents the variable B and the variable C that need to be input in calculating the individual intervention effect to the user, and prompts the user to input or select each value of the variable B and the variable C.

Furthermore, as the processing of step S116, the information processing device 2000 automatically performs the intervention effect calculation in parallel after stratification by the values of the variable B and the variable C, and presents the result to the user.

Furthermore, as the processing of step S117, the information processing device 2000 automatically selects a variable expected to provide the highest calculation accuracy among the variable A, the variable B, and the variable C, calculates the intervention effect using the selected variable, and presents the result to the user. Comparing FIGS. 25 to 27, the minimum number of samples of the variable B is the maximum of 33, the variable B is automatically selected to perform the intervention effect calculation, and the result is presented to the user.

Here, for example, an index of β=1−exp (−N/M) (M is a set value, for example, 30) disclosed in Patent Document 2 may be calculated as an index indicating that the accuracy increases when the number of samples of the automatically selected variable is sufficient. This β is an example of an index indicating that the sample size is sufficient as the sample number N is closer to 1 because the index value approaches 1 as the sample number N is large. When the variable B is applied, since N=33 and M=30, β=0.67, and the value of β can be displayed on the UI screen to give the user an indication of the estimation accuracy.

There are four major advantages brought to the user by presenting such an index R. The first advantage is to prevent the deterioration of the accuracy of the intervention effect calculation (in a case where the variable A is used for the calculation). The second advantage is that the confounding variable can be selected so that the accuracy of the intervention effect calculation is the highest in terms of the degree of satisfiability of the data. As a third advantage, by illustrating the accuracy of the intervention effect calculation to the user and allowing the user to understand in advance the reliability of the intervention effect calculation within the range of the data obtained at the present time, it can be used as a guide when determining the actual action. As a fourth advantage, in calculating the individual intervention effect, even if the values of all the other variables of the intervention variable X are not designated, the individual intervention calculation can be performed as long as the information of the variable B or the variable C narrowed down by the algorithm is designated, and the labor of the user who designates many variables can be reduced.

### I. Summary

Finally, features of the present disclosure and effects brought by each feature will be summarized.

(I-1) When the scale of the causal graph increases, the workload of the user for determining the directions of all the edges becomes excessive, but on the other hand, according to the present disclosure, the intervention effect calculation can be executed if the user determines only the edges adjacent to each of the intervention variable and the reaction variable, and the information of the edge that needs to be directed is presented, so that it is possible to greatly reduce the labor of the user. There is a case where the user is worried about the direction of the cause and effect without being able to determine the direction, but according to the present disclosure, it is possible to prevent the user from falling into such a situation.

(I-2) According to the present disclosure, error information such as absence of a directed path from an intervention variable to a reaction variable and occurrence of a circulation in a causal graph and a coping method are presented, so that a user can know the error and can smoothly cope with the error.

(I-3) According to the present disclosure, since the information as to whether or not there is a sufficient amount of data for performing the intervention effect calculation with high accuracy is presented, the user can select a confounding variable with a sufficient amount of data to perform the intervention effect calculation, or can determine whether or not to perform the intervention effect calculation after accepting that the accuracy cannot be secured. Furthermore, according to the present disclosure, it is possible to automatically select a variable expected to provide the highest calculation accuracy, calculate an intervention effect using the variable, present an index of the calculation accuracy, and give a user an indication of the accuracy.

(I-4) According to the present disclosure, the information on the variable necessary for the calculation of the individual intervention effect is presented in the process of searching for the variable having the sufficient combination of the data amount, so that the user can smoothly determine the value of the necessary variable and perform the individual intervention calculation. Furthermore, according to the present disclosure, it is not necessary to designate a value of an unnecessary variable when calculating an individual intervention effect, and thus it is possible to greatly reduce the labor of input by the user. The user can also obtain information that the result of the intervention effect calculation matches regardless of the value of the variable that does not need to be designated in units of groups of variables for which values are further designated.

### INDUSTRIAL APPLICABILITY

The present disclosure has been described in detail with reference to the specific embodiments. However, it is obvious that those skilled in the art can make modifications and substitutions of the embodiment without departing from the scope of the present disclosure.

The present disclosure can be widely applied when causal inference and multivariable data analysis are performed in various fields such as medicine, pharmacy, engineering, economics, and social science from an academic viewpoint, and in various industrial fields such as industrial, medical, and service industries from an industrial viewpoint. The present disclosure can significantly reduce the user's labor at the time of creating a causal graph and setting variables, and can implement highly accurate intervention effect calculation.

In short, the present disclosure has been described in an illustrative manner, and the contents disclosed in the present specification should not be interpreted in a limited manner. To determine the subject matter of the present disclosure, the claims should be taken into consideration.

Note that the present disclosure may also have the following configurations.

(1) An information processing device including:
a graph inspection unit that performs an inspection of edge direction in a causal graph when performing an intervention effect calculation from an intervention variable to a reaction variable in the causal graph; and
a presentation unit that presents information regarding necessity of directing of a part of edges on the basis of a result of the inspection of edge direction by the graph inspection unit.

(2) The information processing device according to (1), in which
the presentation unit presents information regarding necessity of directing of an edge adjacent to the intervention variable and the reaction variable on the basis of a result of the inspection of edge direction by the graph inspection unit.

(3) The information processing device according to any one of (1) or (2) above, in which
the graph inspection unit inspects a direction of an edge adjacent to the intervention variable and the reaction variable, and
the presentation unit presents an edge that needs to be directed or an edge that does not need to be directed adjacent to the intervention variable and the reaction variable.

(4) The information processing device according to any one of (1) or (2) above, in which
the graph inspection unit inspects presence or absence of a directed path from the intervention variable to the reaction variable, and
the presentation unit presents information indicating an error in a case where there is no directed path from the intervention variable to the reaction variable.

(5) The information processing device according to (4) above, in which
the presentation unit presents information of any one of forming a directed path from the intervention variable to the reaction variable and selecting an intervention variable having a directed path.

(6) The information processing device according to (1) above, in which
the graph inspection unit inspects presence or absence of a circulation in the causal graph, and
the presentation unit performs at least one of error display or presentation of information on a return path in a case where a circulation occurs in the causal graph.

(7) The information processing device according to any one of (1) to (6) above, further including:
a user input unit that receives correction of information presented by the presentation unit from the user; and
an intervention effect calculation unit that calculates an intervention effect from the intervention variable to the reaction variable on the basis of the causal graph corrected via the input unit.

(8) The information processing device according to (7) above, in which
the intervention effect calculation unit calculates an intervention effect from the intervention variable to the reaction variable on the basis of the causal graph corrected to direct a part of an undirected edge via the input unit.

(9) The information processing device according to any one of (7) or (8) above, in which
the intervention effect calculation unit calculates an intervention effect from the intervention variable to the reaction variable on the basis of a causal graph corrected in such a manner that only an undirected edge adjacent to the intervention variable is directed via the input unit.

(10) The information processing device according to any one of (1) to (9) above, further including:
a variable extraction unit that extracts a set of confounding variables that satisfy a backdoor criterion regardless of a direction of an undirected edge in the causal graph; and
an intervention effect calculation unit that calculates an intervention effect from an intervention variable to a reaction variable by averaging, with a distribution of each of the confounding variables, results of evaluating a causal effect from the intervention variable to the reaction variable as a conditional distribution when stratified by the confounding variables that satisfy the backdoor criterion.

(11) The information processing device according to (10) above, further including:
a confounding variable search unit that searches for a confounding variable to be used for intervention effect calculation on the basis of a result of aggregation of a combination of a value of the intervention variable and a value of the confounding variable; and
a second presentation unit that presents information based on a result of the inspection by the confounding variable inspection unit.

(12) The information processing device according to (11) above, in which
the second presentation unit presents whether or not a combined data amount is sufficient.

(13) The information processing device according to (11) above, in which
the second presentation unit performs at least one of presentation of information regarding selection of a confounding variable to be used for intervention effect calculation, provision of a function of performing highly reliable selection with a largest amount of data among a plurality of the confounding variables to perform intervention effect calculation and presentation of an index value regarding reliability of the selection, or presentation of information regarding a variable that needs input for an individual intervention effect, in a case where there is a plurality of confounding variables with a sufficiently sufficient amount of data in combination.

(14) The information processing device according to (13) above, in which
the intervention effect calculation unit automatically calculates an individual intervention effect after stratification with each of values of the confounding variables, and the second presentation unit presents a result of the calculation.

(15) The information processing device according to (11) above, in which
the intervention effect calculation unit calculates an intervention effect by using a combination that is capable of calculating with highest accuracy.

(16) The information processing device according to (11) above, in which
the intervention effect calculation unit calculates an intervention effect by using a combination that is capable of calculating with highest accuracy, and presents an index value regarding accuracy at that time.

(17) The information processing device according to (11) above, in which
the second presentation unit presents information regarding a combination having an insufficient data amount.

(18) The information processing device according to (11) above, in which
the second presentation unit warns that there is a combination for which data amount is insufficient, and inquires whether or not to execute intervention effect calculation.

(19) An information processing method including:
a graph inspection step of performing an inspection of edge direction in a causal graph when performing an intervention effect calculation from an intervention variable to a reaction variable in the causal graph; and
a presentation step of presenting information regarding necessity of directing of a part of edges on the basis of a result of the inspection of edge direction by the graph inspection step.

(20) A computer program described in a computer readable format to cause a computer to function as:
a graph inspection unit that performs an inspection of edge direction in a causal graph when performing an intervention effect calculation from an intervention variable to a reaction variable in the causal graph; and
a presentation unit that presents information regarding necessity of directing of a part of edges on the basis of a result of the inspection of edge direction by the graph inspection unit.

### REFERENCE SIGNS LIST

2000 Information processing device
2001 CPU
2002 ROM
2003 RAM
2004 Host bus
2005 Bridge
2006 Expansion bus
2007 Interface unit
2008 Input unit
2009 Output unit
2010 Storage unit
2011 Drive
2012 Removable recording medium
2013 Communication unit

1. An information processing device comprising:
a graph inspection unit that performs an inspection of edge direction in a causal graph when performing an intervention effect calculation from an intervention variable to a reaction variable in the causal graph; and
a presentation unit that presents information regarding necessity of directing of a part of edges on a basis of a result of the inspection of edge direction by the graph inspection unit.

2. The information processing device according to claim 1, wherein
the presentation unit presents information regarding necessity of directing of an edge adjacent to the intervention variable and the reaction variable on a basis of a result of the inspection of edge direction by the graph inspection unit.

3. The information processing device according to claim 1, wherein
the graph inspection unit inspects a direction of an edge adjacent to the intervention variable and the reaction variable, and
the presentation unit presents an edge that needs to be directed or an edge that does not need to be directed adjacent to the intervention variable and the reaction variable.

4. The information processing device according to claim 1, wherein
the graph inspection unit inspects presence or absence of a directed path from the intervention variable to the reaction variable, and
the presentation unit presents information indicating an error in a case where there is no directed path from the intervention variable to the reaction variable.

5. The information processing device according to claim 4, wherein
the presentation unit presents information of any one of forming a directed path from the intervention variable to the reaction variable and selecting an intervention variable having a directed path.

6. The information processing device according to claim 1, wherein
the graph inspection unit inspects presence or absence of a circulation in the causal graph, and
the presentation unit performs at least one of error display or presentation of information on a return path in a case where a circulation occurs in the causal graph.

7. The information processing device according to claim 1, further comprising:
a user input unit that receives correction of information presented by the presentation unit from the user; and
an intervention effect calculation unit that calculates an intervention effect from the intervention variable to the reaction variable on a basis of the causal graph corrected via the input unit.

8. The information processing device according to claim 7, wherein
the intervention effect calculation unit calculates an intervention effect from the intervention variable to the reaction variable on a basis of the causal graph corrected to direct a part of an undirected edge via the input unit.

9. The information processing device according to claim 7, wherein
the intervention effect calculation unit calculates an intervention effect from the intervention variable to the reaction variable on a basis of a causal graph corrected in such a manner that only an undirected edge adjacent to the intervention variable is directed via the input unit.

10. The information processing device according to claim 1, further comprising:
a variable extraction unit that extracts a set of confounding variables that satisfy a backdoor criterion regardless of a direction of an undirected edge in the causal graph; and
an intervention effect calculation unit that calculates an intervention effect from an intervention variable to a reaction variable by averaging, with a distribution of each of the confounding variables, results of evaluating a causal effect from the intervention variable to the reaction variable as a conditional distribution when stratified by the confounding variables that satisfy the backdoor criterion.

11. The information processing device according to claim 10, further comprising:
a confounding variable search unit that searches for a confounding variable to be used for intervention effect calculation on a basis of a result of aggregation of a combination of a value of the intervention variable and a value of the confounding variable; and
a second presentation unit that presents information based on a result of the inspection by the confounding variable inspection unit.

12. The information processing device according to claim 11, wherein
the second presentation unit presents whether or not a combined data amount is sufficient.

13. The information processing device according to claim 11, wherein
the second presentation unit performs at least one of presentation of information regarding selection of a confounding variable to be used for intervention effect calculation, provision of a function of performing highly reliable selection with a largest amount of data among a plurality of the confounding variables to perform intervention effect calculation and presentation of an index value regarding reliability of the selection, or presentation of information regarding a variable that needs input for an individual intervention effect, in a case where there is a plurality of confounding variables with a sufficiently sufficient amount of data in combination.

14. The information processing device according to claim 13, wherein
the intervention effect calculation unit automatically calculates an individual intervention effect after stratification with each of values of the confounding variables, and the second presentation unit presents a result of the calculation.

15. The information processing device according to claim 11, wherein
the intervention effect calculation unit calculates an intervention effect by using a combination that is capable of calculating with highest accuracy.

16. The information processing device according to claim 11, wherein
the intervention effect calculation unit calculates an intervention effect by using a combination that is capable of calculating with highest accuracy, and presents an index value regarding accuracy at that time.

17. The information processing device according to claim 11, wherein
the second presentation unit presents information regarding a combination having an insufficient data amount.

18. The information processing device according to claim 11, wherein
the second presentation unit warns that there is a combination for which data amount is insufficient, and inquires whether or not to execute intervention effect calculation.

19. An information processing method comprising:
a graph inspection step of performing an inspection of edge direction in a causal graph when performing an intervention effect calculation from an intervention variable to a reaction variable in the causal graph; and
a presentation step of presenting information regarding necessity of directing of a part of edges on a basis of a result of the inspection of edge direction by the graph inspection step.

20. A computer program described in a computer readable format to cause a computer to function as:
a graph inspection unit that performs an inspection of edge direction in a causal graph when performing an intervention effect calculation from an intervention variable to a reaction variable in the causal graph; and
a presentation unit that presents information regarding necessity of directing of a part of edges on a basis of a result of the inspection of edge direction by the graph inspection unit.
